(19) United States
(12) Patent Application Publication
(10) Pub. No.: US 2026/0252146 A1
(43) Pub. Date: Aug. 27, 2026

(54) ELECTRONIC APPARATUS COMPRISING FLEXIBLE DISPLAY

(71) Applicant: Samsung Electronics Co., Ltd., Suwon-si (KR)

(72) Inventors: Bora LEE, Suwon-si (KR); Seokki KIM, Suwon-si (KR); Taehyeong RYU, Suwon-si (KR); Jungkyu PARK, Suwon-si (KR); Gyuhyun BYUN, Suwon-si (KR); Jungwon BYUN, Suwon-si (KR); Suyoel RYU, Suwon-si (KR); Wonho LEE, Suwon-si (KR); Youngkyong JO, Suwon-si (KR)

(21) Appl. No.: 19/648,671

(22) Filed: Apr. 15, 2026

Related U.S. Application Data
(63) Continuation of application No. PCT/KR2024/014746, filed on Sep. 27, 2024.

(30) Foreign Application Priority Data
Oct. 17, 2023 (KR) 10-2023-0139100
Dec. 8, 2023 (KR) 10-2023-0177687

(51) Int. Cl. G06F 1/16

(52) U.S. Cl. CPC G06F 1/1656; G06F 1/1652; G06F 1/1681

(57) ABSTRACT

An electronic device is provided. The electronic device includes a display having a folding region bendable by a predetermined angle in at least one direction, wherein a rib and a slit of a specific pattern repeatedly extend in a direction parallel to a folding axis in a glass layer included in the folding region, wherein a slit length corresponding to a distance between a first bridge corresponding to a start point of the slit and a second bridge corresponding to an end point of the slit is determined based on at least one of a thickness of the glass layer or a modulus of a polymer filling the slit, and wherein the first bridge and the second bridge are configured to connect a first rib and a second rib disposed in parallel on two opposite sides of the slit.

### CROSS-REFERENCE TO RELATED APPLICATION(S)

This application is a continuation application, claiming priority under 35 U.S.C. § 365 (c), of an International application No. PCT/KR2024/014746, filed on Sep. 27, 2024, which is based on and claims the benefit of a Korean patent application number 10-2023-0139100, filed on Oct. 17, 2023, in the Korean Intellectual Property Receiving Office, and of a Korean patent application number 10-2023-0177687, filed on Dec. 8, 2023, in the Korean Intellectual Property Receiving Office, the disclosure of each of which is incorporated by reference herein in its entirety.

### BACKGROUND

### 1. Field

The disclosure relates to an electronic device including a flexible display in which a pattern glass is used.

### 2. Description of Related Art

An electronic device (e.g., a smartphone or a tablet) may provide visual information to a user using a display. A form factor considering portability convenience and/or ease of information provision may be applied to the electronic device. The ease of information provision may be defined by an amount of visual information that the electronic device may deliver at once through the display. For example, an electronic device having a large display area may have relatively higher ease in providing visual information compared to an electronic device having a small display area.

The electronic device is undergoing a change to a form factor that may increase portability convenience while also increasing ease of information provision. For example, the electronic device may have a form factor capable of varying a display area, such as rollable, slidable, or foldable, rather than a traditional form factor, such as a bar type.

An electronic device having a form factor capable of varying the display area (hereinafter referred to as a “flexible display device”) may include a flexible display capable of shape deformation of the display by bending or folding. As the number or frequency of deformation of the flexible display increases, stress exceeding an elastic limit of a protective layer (e.g., yield strength) may be applied, and plastic deformation may occur. In this case, distortion or transparency degradation may occur in the flexible display due to a crease or a scratch. The lifespan of the flexible display may be shortened due to repetitive deformation, and an element and line may be damaged.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a flexible display in which a pattern glass is used.

Additional aspects will be set forth in part in the description which follows and, in part, will be apparent from the description, or may be learned by practice of the presented embodiments.

According to an embodiment of the disclosure, an electronic device is provided. The electronic device includes a display having a folding region bendable by a predetermined angle in at least one direction, wherein a rib and a slit of a specific pattern repeatedly extend in a direction parallel to a folding axis (A) in a glass layer included in the folding region, wherein a slit length (D3) corresponding to a distance between a first bridge corresponding to a start point of the slit and a second bridge corresponding to an end point of the slit is determined based on at least one of a thickness of the glass layer or a modulus of a polymer filling the slit, and wherein the first bridge and the second bridge are configured to connect a first rib and a second rib disposed in parallel on two opposite sides of the slit.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device capable of performing operations described according to an embodiment of the disclosure;

FIGS. 2A, 2B, 2C, 2D, 2E, and 2F illustrate an electronic device having a housing structure of an in-folding type according to various embodiments of the disclosure;

FIG. 3 is a stacked structure diagram illustrating a display in an electronic device according to an embodiment of the disclosure;

FIG. 4A is a plan view illustrating a flexible display including a folding region in an electronic device according to an embodiment of the disclosure;

FIG. 4B is a side cross-sectional view illustrating a display protective member included in a flexible display in an electronic device according to an embodiment of the disclosure;

FIG. 4C is an enlarged cross-sectional view illustrating a hinge portion for folding of a flexible display in an electronic device according to an embodiment of the disclosure;

FIG. 5A is a view illustrating a folding region provided based on a folding axis for a folding operation in an electronic device according to an embodiment of the disclosure;

FIG. 5B or 5C is a side view illustrating a folding operation of a display protective member according to various embodiments of the disclosure;

FIGS. 6A, 6B, and 6C are enlarged plan views illustrating a partial region in a folding region included in a glass layer of a flexible display according to various embodiments of the disclosure;

FIG. 7A or 7B is a structure diagram illustrating a pattern glass in a folding region of a flexible display according to various embodiments of the disclosure;

FIG. 8A is a side cross-sectional view (e.g., A-A′ of FIG. 5A) of a flexible display according to an embodiment of the disclosure;

FIG. 8B is a cross-sectional view as seen from a cutting line (B-B′) of FIG. 8A according to an embodiment of the disclosure;

FIGS. 9A, 9B, 9C, 9D, 9E, and 9F are cross-sectional views (e.g., A-A′ of FIG. 5A) of a display protective member included in a flexible display to which side protective coating is applied according to various embodiments of the disclosure;

FIG. 10 is a view illustrating a process procedure for forming a side protective layer included in a flexible display according to an embodiment of the disclosure;

FIG. 11 is a view illustrating examples to which a side protective coating structure of a flexible display may be applied according to an embodiment of the disclosure;

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary those of ordinary skill in the art will recognize various changes and modifications of the various embodiments described herein can be made without departing from the scope and spirit of the disclosure. In addition, descriptions of well-known functions and configurations may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure, a flexible display module including a pattern glass in which slits of a folding portion in an electronic device are configured to have buckling stability may be provided.

In various embodiments of the disclosure, an electronic device in which a coating layer for protecting a side surface of a glass layer included in a display module is configured by stacking polymer layers having different moduli may be provided.

According to an embodiment of the disclosure, buckling stability may be increased while lowering stress and reaction force of a pattern glass having a plurality of slits, and a peeling phenomenon of a protective layer and a glass layer due to buckling may be prevented. Further, a polymer exposed on a side surface may be protected, management of foreign objects/handling may be facilitated, and repeated bending may be enabled.

The technical objects of the disclosure are not limited to the foregoing, and other technical objects may be derived by one of ordinary skill in the art from example embodiments of the disclosure.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

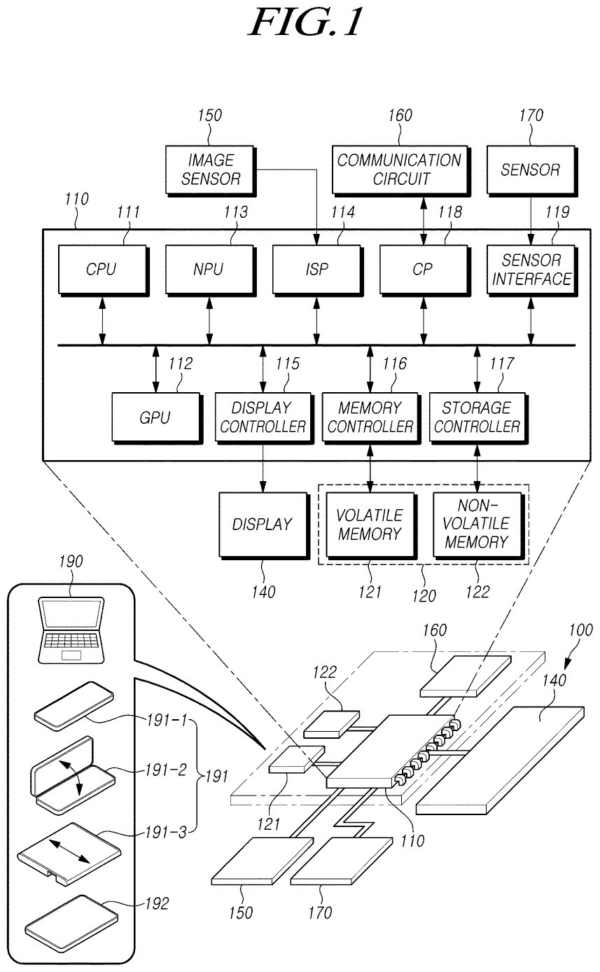

FIG. 1 is a block view illustrating an electronic device capable of performing operations described according to an embodiment of the disclosure.

Referring to FIG. 1, an electronic device 100 may be one of various types of electronic devices, such as a laptop computer 190, smartphones 191 having various form factors (e.g., a bar-type smartphone 191-1, a foldable-type smartphone 191-2, or a slidable (or rollable) smartphone 191-3), a tablet 192, a cellular phone (not shown), and other similar computing devices (not shown). The components illustrated in FIG. 1, and their relationships and functions do not limit implementations described or claimed in the disclosure. The electronic device 100 may be referred to as a mobile device, a user device, a multifunctional device, a portable device, or a server.

The electronic device 100 may include components including a processor 110, memory 120 (e.g., the volatile memory 121 and/or the non-volatile memory 122), a display 140, an image sensor 150, a communication circuit 160, and/or a sensor 170. The above-described components are merely exemplary. For example, the electronic device 100 may include other components (e.g., a power management integrated circuit (PMIC), an audio processing circuit, an antenna module, a rechargeable battery, or an input/output interface). For example, some components may be omitted from the electronic device 100. For example, some components may be integrated into one component.

The processor 110 may be implemented as one or more integrated circuit (IC) chips and may perform various data processing. For example, the processor 110 (or an application processor (AP)) may be implemented as a system on chip (SoC) (e.g., one chip or chipset). The processor 110 may include sub components including a central processing unit (CPU) 111, a graphics processing unit (GPU) 112, a neural processing unit (NPU) 113, an image signal processor (ISP) 114, a display controller 115, memory controller 116, a storage controller 117, a communication processor (CP) 118, and/or a sensor interface 119. The sub components are merely exemplary. For example, processor 110 may further include other sub components. For example, some sub components may be omitted from the processor 110. For example, some sub components may be included as separate components of the electronic device 100 outside the processor 110. For example, some sub components may be included in other components (e.g., the display 140 and the image sensor 150).

The processor 110 (e.g., the CPU 111 or the central processing circuit) may be configured to control sub components based on execution of instructions stored in the memory 120 (e.g., the volatile memory 121 and/or the non-volatile memory 122). The GPU 112 (or the graphics processing circuit) may be configured to execute parallel computations (e.g., rendering). The NPU 113 (or neural processing circuit) may be configured to execute operations (e.g., convolution computations) for an artificial intelligence model. The ISP 114 (or the image signal processing circuit) may be configured to process a raw image obtained through the image sensor 150 into a format suitable for a component in the electronic device 100 or a sub component in the processor 110. The display controller 115 (or the display control circuit) may be configured to process an image obtained from the CPU 111, the GPU 112, the ISP 114, or the memory 120 (e.g., the volatile memory 121) into a format suitable for the display 140. The memory controller 116 (or the memory control circuit) may be configured to control to read data from the volatile memory 121 and write the data to the volatile memory 121. The storage controller 117 (or the storage control circuit) may be configured to read data from the non-volatile memory 122 and control to write the data to the non-volatile memory 122. The CP 118 (communication processing circuit) may be configured to process data obtained from a sub component in the processor 110 into a format suitable for transmitting the data to another electronic device through the communication circuit 160, or to process data obtained from the other electronic device through the communication circuit 160 into a format suitable for processing by the sub component. The sensor interface 119 (or a sensing data processing circuit or a sensor hub) may be configured to process data about the state of the electronic device 100 and/or the state of the surroundings of the electronic device 100, which is obtained through the sensor 170, into a format suitable for a sub component in the processor 110.

A display (e.g., the display 140 of FIG. 1) of an electronic device (e.g., the electronic device 100 of FIG. 1) may be implemented by stacking at least a plurality of layers, and this may be referred to as a “display stacked structure.” At least a plurality of members constituting the display stacked structure may be fixed by an adhesive. The adhesive may be implemented as one layer having a predetermined thickness, and such a layer may be referred to as an “adhesive layer.”

According to an example, a flexible display may have limitations in effectively responding to deformation characteristics of the flexible display because a material of an adhesive forming an adhesive layer corresponding to a region having a high frequency of deformation (hereinafter referred to as a “folding region” or a “folding portion”) and a region having a low frequency of deformation (hereinafter referred to as a “non-folding region” or a “flat portion”) is uniform.

According to an example, a flexible display used in an electronic device 100 having a form factor, such as slidable or foldable requires a flexible protective layer capable of being bent or folded together with a display panel. The protective layer may have a flexible characteristic, such as, e.g., transparent polyimide or ultra-thin glass.

During a bending operation of the flexible display, in case that a panel side protective member including a joint portion is used, a gap may be created between a panel side surface and the protective member by a bending operation, and external foreign objects, such as sand and dust may intrude into the panel side surface. Further, a panel side protective member including a joint portion having complex movability is assembled to a side surface of the flexible display through a separate assembly process, and thus a manufacturing process of the electronic device may be complex.

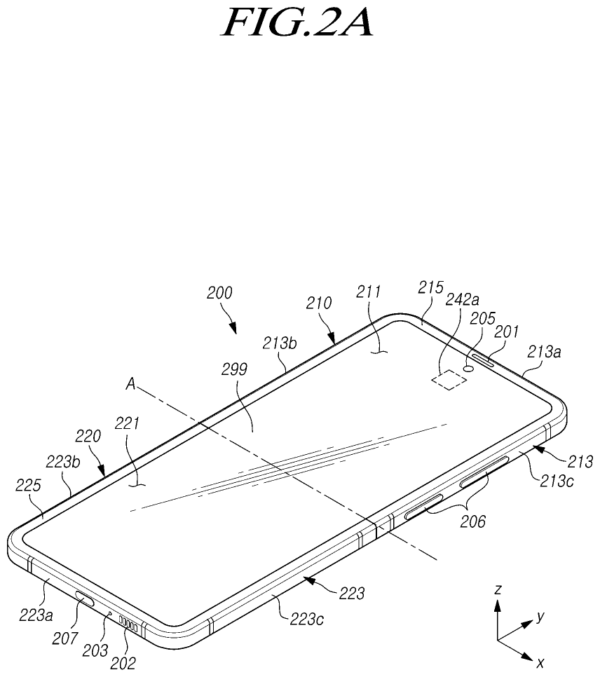

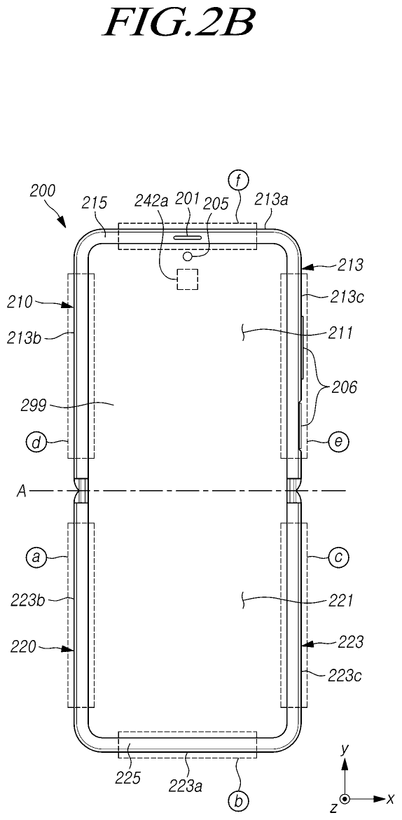

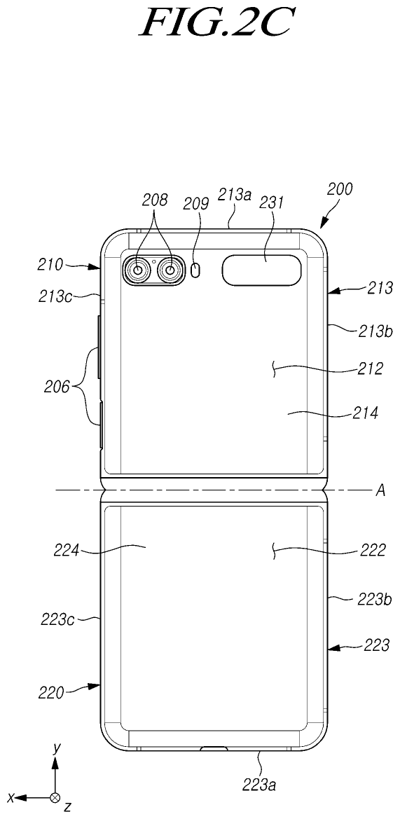

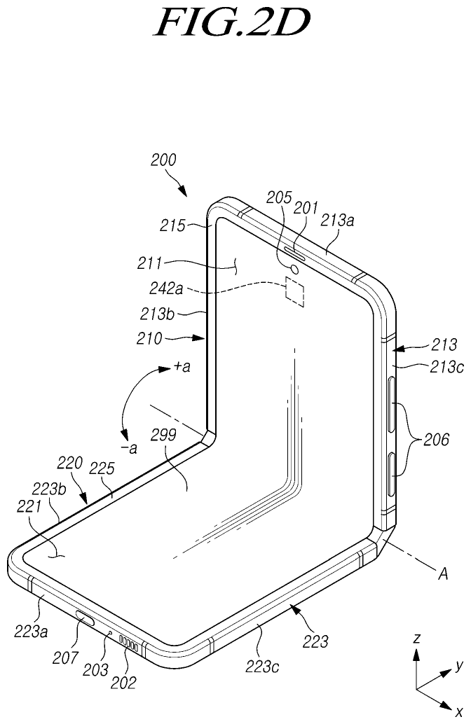

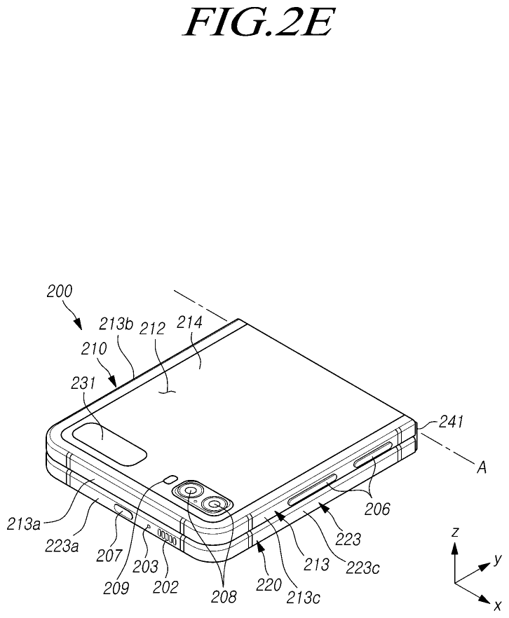

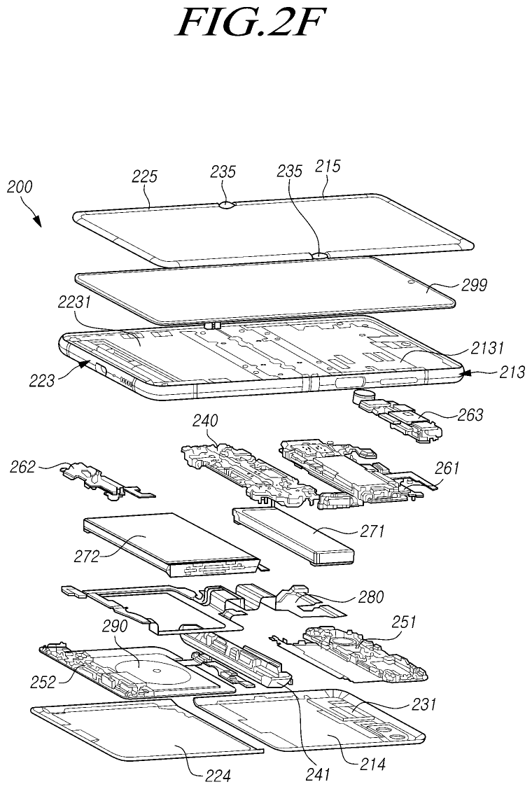

FIGS. 2A, 2B, 2C, 2D, 2E, and 2F illustrate an electronic device 200 (e.g., the electronic device 100 of FIG. 1) having a flexible display with a housing structure of an in-folding type according to various embodiments of the disclosure. Hereinafter in the disclosure, the electronic device 200 may be understood as indicating an electronic device having a flexible display. Specifically, FIG. 2A is a front perspective view illustrating the electronic device 200 in an unfolded (flat or open) state, FIG. 2B is a front view illustrating the electronic device 200 in the unfolded state, FIG. 2C is a rear view illustrating the electronic device 200 in a folded (or closed) state, FIG. 2D is a front perspective view illustrating the electronic device 200 in a partially folded state (in other words, a partially unfolded state, or an intermediate state (free stop state) between a fully folded state and a fully unfolded state), FIG. 2E is a rear perspective view illustrating the electronic device 200 in the unfolded state, and FIG. 2F is an exploded perspective view illustrating the electronic device 200.

Referring to FIGS. 2A, 2B, 2C, and 2D, the electronic device 200 (e.g., the electronic device 100 of FIG. 1) may include a first housing 210, a second housing 220, a hinge assembly 240, a display 299 (e.g., the display 140 of FIG. 1), or a sensor module (e.g., the sensor module 170 of FIG. 1). The hinge assembly 240 may be configured to connect the first housing 210 and the second housing 220 such that the second housing 220 is rotatable about the first housing 210. The display 299 may include a flexible display or a foldable display disposed within a space formed by a foldable housing including the first housing 210 and the second housing 220. In the following description, a “flexible display” is used to indicate a display operating, or having a structure to operate, such that a screen size of the display is substantially variable.

The display 299 may be disposed from the first housing 210 across the hinge assembly 240 to the second housing 220. The display 299 may be divided into a first display region 211 disposed in an inner space of the first housing 210 and a second display region 221 disposed in an inner space of the second housing 220 based on the folding axis A. The sensor module (e.g., an illuminance sensor) may be disposed below a sensor region (or light transmission region) 242a of the first display region 211 in case of being viewed facing the front. A position and/or size of the sensor region 242a in the first display region 211 may be determined by a position and/or size of the illuminance sensor disposed therebelow. For example, a size (e.g., a diameter) of the sensor region 242a may be determined based on a field of view (FOV) of the illuminance sensor. As an example, the sensor region 242a may be configured to have a lower pixel density and/or a lower line density than its surroundings for enhancing light transmittance. The display 299 may include a protective layer 298 including a transparent material and protecting a panel layer from external foreign objects and impact.

The hinge assembly 240 may be implemented in an in-folding manner such that the two display regions 211, 221 face each other in case that the electronic device 200 is state-transitioned from the unfolded state (e.g., the state of FIG. 2A) to the folded state (e.g., the state of FIG. 2E). In case that the electronic device 200 is in the unfolded state, the two display regions 211, 221 may face substantially the same direction. As the electronic device 200 is state-transitioned from the unfolded state to the folded state, the two display regions 211, 221 may be rotated in a direction facing each other. The hinge assembly 240 may be configured such that the foldable housing 210, 220 has a resistance force against rotation. The foldable housing 210, 220 may be rotated in case that an external force exceeding the resistance force is applied to the foldable housing 210, 220.

A state of the electronic device 200 may be defined based on an angle formed between the two display regions 211, 221. In case that the angle between the two display regions 211, 221 is about 180 degrees, the state of the electronic device 200 may be defined as an unfolded (flat or open) state. In case that the angle between the two display regions 211, 221 is between about 0 degrees and 10 degrees, the state of the electronic device 200 may be defined as a folded (or closed) state. In case that the two display regions 211, 221 form an angle greater than the angle in the folded state and smaller than the angle in the unfolded state (e.g., between about 10 degrees and 179 degrees), the state of the electronic device 200 may be defined as an intermediate state (in other words, a partially folded or partially unfolded state) as illustrated in FIG. 2D.

Based on the state of the electronic device 200, an activation region in which visual information (e.g., text, image, or icon) is to be displayed in the display 299 may be determined. In case that the electronic device 200 is in the intermediate state, the activation region may be determined as the first display region 211 or the second display region 221. A region having relatively less movement among the first display region 211 and the second display region 221 may be determined as the activation region. For example, in case that a user opens another housing with a finger (e.g., thumb) of the same hand or another hand while gripping a housing of the electronic device 200 with one hand, the electronic device 200 may be state-transitioned from the folded state to the intermediate state. Accordingly, the electronic device 200 may determine a display region of the gripped housing (i.e., a housing with relatively less movement) as the activation region. In case that the electronic device 200 is in the unfolded state, an entire region (e.g., both the first display region 211 and the second display region 221) of the display 299 may be determined as the activation region.

The first housing 210 may include, in the unfolded state, a first surface (first display region) 211 facing a first direction (e.g., front direction) (z-axis direction) and a second surface (first rear surface) 212 facing a second direction (e.g., rear direction) (−z-axis direction) opposite to the first direction. The second housing 220 may include, in the unfolded state, a third surface (second display region) 221 facing the first direction (e.g., z-axis direction) and a fourth surface (second rear surface) 222 facing the second direction (e.g., −z-axis direction).

The electronic device 200 may operate such that, in the unfolded state, the first display region 211 and the second display region 221 both face the first direction (e.g., z-axis direction), and in the folded state, the first display region 211 and the second display region 221 face each other. The electronic device 200 may be operated such that, in the unfolded state, the first rear surface 212 and the second rear surface 222 both face the second direction (−z-axis direction), and in the folded state, the first rear surface 212 and the second rear surface 222 face opposite directions.

The first housing 210 may include a first side frame 213 at least partially forming an exterior of the electronic device 200. The first housing 210 may include a first rear cover 214 coupled to the first side frame 213 and forming at least a portion of the first rear surface 212. The first side frame 213 may include a first side surface 213a, a second side surface 213b extending from one end of the first side surface 213a, and a third side surface 213c extending from the other end of the first side surface 213a. The first side frame 213 may have a rectangular (e.g., square or rectangular) shape through the first side surface 213a, the second side surface 213b, and the third side surface 213c.

A portion of the first side frame 213 may be formed of a conductor. For example, a portion \textcircled{f} of the first side surface 213a, a portion \textcircled{d} of the second side surface 213b, and/or a portion \textcircled{e} of the third side surface 213c may be formed of a metallic material that is a conductor (e.g., see FIG. 2B). The conductor may be electrically connected to a grip sensor (not illustrated) disposed in an inner space of the first housing 210 adjacent thereto. The electronic device 200 may recognize, by the grip sensor, that a dielectric (e.g., finger, palm, face) has approached (or contacted) the first housing 210, and a location in the first housing 210 where the dielectric has contacted (e.g., the first side surface 213a, the second side surface 213b, the third side surface 213c).

The second housing 220 may include a second side frame 223 at least partially forming the exterior of the electronic device 200. The second housing 220 may include a second rear cover 224 coupled to the second side frame 223 and forming at least a portion of the second rear surface 222. The second side frame 223 may include a fourth side surface 223a, a fifth side surface 223b extending from one end of the fourth side surface 223a, and a sixth side surface 223c extending from the other end of the fourth side surface 223a. The second side frame 223 may have a rectangular shape through the fourth side surface 223a, the fifth side surface 223b, and/or the sixth side surface 223c.

A portion of the second side frame 223 may be formed of a conductor. For example, a portion \textcircled{b} of the fourth side surface 223a, a portion \textcircled{a} of the fifth side surface 223b, and a portion \textcircled{c} of the sixth side surface 223c may be formed of a metallic material that is a conductor (e.g., see FIG. 2B). The conductor may be electrically connected to a grip sensor (not illustrated) disposed in an inner space of the second housing 220 adjacent thereto. The electronic device 200 may recognize, by the grip sensor, that a dielectric has approached (or contacted) the second housing 220, and a location in the second housing 220 where the dielectric has contacted (e.g., the fourth side surface 223a, the fifth side surface 223b, the sixth side surface 223c).

The pair of housings 210, 220 is not limited to the illustrated form and combination, and may be implemented by a combination and/or coupling of other shapes or components. For example, the first side frame 213 may be formed integrally with the first rear cover 214. For example, the second side frame 223 may be formed integrally with the second rear cover 224.

The first rear cover 214 and the second rear cover 224 may be formed by, e.g., at least one or a combination of at least two of coated or tinted glass, ceramic, polymer, or metal (e.g., aluminum, stainless steel (STS), or magnesium).

The electronic device 200 may include a first protective cover 215 (e.g., first protective frame or first decorative member) coupled along an edge of the first housing 210. The electronic device 200 may include a second protective cover 225 (e.g., second protective frame or second decorative member) coupled along an edge of the second housing 220. The first protective cover 215 and/or the second protective cover 225 may be formed of a metal or polymer material.

The electronic device 200 may include a sub display module 231 disposed separately from the display 299. The sub display module 231 may display state information of the electronic device 200 in the folded state by being disposed to be at least partially exposed on the first rear surface 212. The sub display module 231 may be disposed to be visible from the outside through at least a partial region of the first rear cover 214. The sub display module 231 may also be disposed on the second rear cover 224. In such a case, the sub display module 231 may be disposed to be visible from the outside through at least a partial region of the second rear cover 224.

The electronic device 200 may include at least one of an input device 203, a sound output device 201, 202, a camera module 205, 208, a key input device 206, a connector port 207, or a sensor module (not illustrated) (e.g., the sensor module 176 of FIG. 1). The sensor module and/or the camera 205 may be disposed below the display 299 in case of being viewed facing the front.

The electronic device 200 may be operated to maintain the intermediate state through the hinge assembly 240 (e.g., see FIG. 2D). In such a case, the electronic device 200 may control the display 299 such that different content is displayed in a display region corresponding to the first display region 211 and a display region corresponding to the second display region 221.

Referring to FIG. 2F, the electronic device 200 may include a first side frame 213, a second side frame 223, or a hinge assembly 240 rotatably connecting the first side frame 213 and the second side frame 223. The electronic device 200 may include a first support plate 2131 at least partially extending from the first side frame 213 or a second support plate 2231 at least partially extending from the second side frame 223. The first support plate 2131 may be formed integrally with the first side frame 213 or may be structurally coupled to the first side frame 213. Similarly, the second support plate 2231 may be formed integrally with the second side frame 223 or may be structurally coupled to the second side frame 223. The electronic device 200 may include a display 299 disposed to be supported by the first support plate 2131 and/or the second support plate 2231. The electronic device 200 may include a first rear cover 214 coupled to the first side frame 213 and providing a first space between itself and the first support plate 2131. The electronic device 200 may include a second rear cover 224 coupled to the second side frame 223 and providing a second space between itself and the second support plate 2231. The first side frame 213 and the first rear cover 214 may also be formed integrally. The second side frame 223 and the second rear cover 224 may be formed integrally. The electronic device 200 may include a first housing 210 provided through the first side frame 213, the first support plate 2131, and/or the first rear cover 214. The electronic device 200 may include a second housing 220 provided through the second side frame 223, the second support plate 2231, and/or the second rear cover 224.

Although not illustrated, the hinge assembly 240 may include a first arm structure coupled to the first housing 210 (e.g., the first support plate 2131) or a second arm structure coupled to the second housing 220 (e.g., the second support plate 2231). The hinge assembly 240 may include a detent structure physically contacting the first arm structure and the second arm structure such that the first housing 210 and/or the second housing 220 has a resistance force against rotation. The foldable housing 210, 220 may have a resistance force against rotation due to a contact force (e.g., a force pushing the first arm structure and the second arm structure) of the detent structure.

The electronic device 200 may include a first board assembly 261 (e.g., main printed circuit board), a camera assembly 263, a first battery 271, or a first bracket 251 disposed in the first space between the first side frame 213 and the first rear cover 214. The camera assembly 263 may include a plurality of cameras (e.g., the camera modules 205, 208 of FIGS. 2A and 2C). The camera assembly 263 may be electrically connected to the first board assembly 261. The first bracket 251 may provide a support structure and enhanced rigidity for supporting the first board assembly 261 and/or the camera assembly 263.

The electronic device 200 may include a second board assembly 262 (e.g., sub printed circuit board), an antenna 290 (e.g., coil member), a second battery 272, or a second bracket 252 disposed in the second space between the second side frame 223 and the second rear cover 224.

The electronic device 200 may include a line member 280 (e.g., flexible circuit (flexible printed circuit board (FPCB))) disposed to extend from the first board assembly 261 across the hinge assembly 240 to a plurality of electronic components (e.g., the second board assembly 262, the second battery 272, or the antenna 290) disposed between the second side frame 223 and the second rear cover 224, and providing an electrical connection.

The electronic device 200 may include a hinge cover 241 supporting the hinge assembly 240. The hinge cover 241 may be exposed to the outside in case that the electronic device 200 is in the folded state, and may be retracted into the first space and the second space in case that it is in the unfolded state. The hinge cover 241 may be disposed not to be exposed to the outside in case of being retracted into the second space.

The electronic device 200 may include a first protective cover 215 coupled along an edge of the first side frame 213. The electronic device 200 may include a second protective cover 225 coupled along an edge of the second side frame 223. The first protective cover 215 may be configured to protect an edge of the first display region 211 included in the display 299. The second protective cover 225 may be configured to protect an edge of the second display region 221 included in the display 299. The electronic device 200 may include a protective cap 235. The protective cap 235 may be disposed in a region corresponding to the hinge assembly 240 to protect a bent portion at an edge of the display 299.

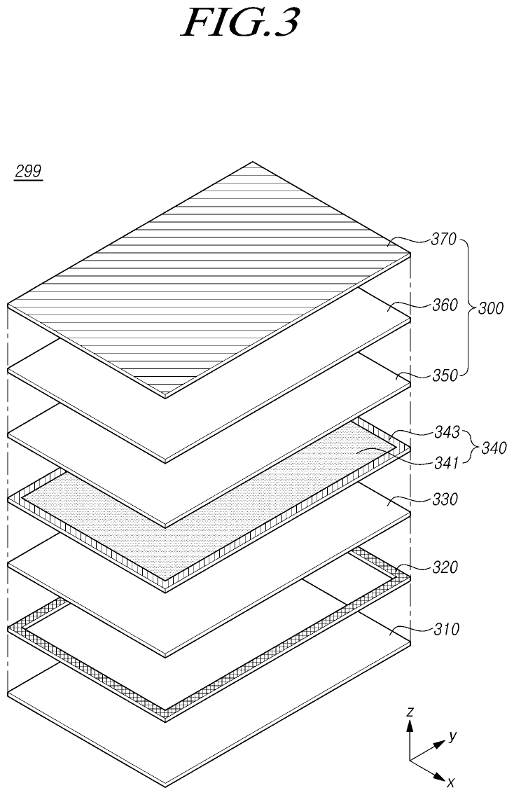

FIG. 3 is a stacked structure diagram illustrating a display (e.g., the display 140 of FIG. 1 or the display 299 of FIGS. 2A, 2B, 2C, 2D, 2E, and 2F) in an electronic device (e.g., the electronic device 100 of FIG. 1 or the electronic device 200 of FIGS. 2A, 2B, 2C, 2D, 2E, and 2F) according to an embodiment of the disclosure. Hereinafter, for convenience of description, reference numeral ‘200’ is used to indicate the electronic device, and reference numeral ‘299’ is used to indicate the display.

Referring to FIG. 3, a display 299 included in an electronic device 200 may have a multi-layer structure in which a plurality of layers are stacked. An adhesive layer 340, 360 may be provided at a boundary surface of the plurality of layers. The display 299 to be described below is not limited to a display applied to the display 299 described in connection to FIGS. 2A, 2B, 2C, 2D, 2E, and 2F, and may be applied to various forms of displays. For example, the display 299 to be described below may be substantially identically applied to an electronic device 200 having various form factors operating such that one housing (e.g., the first housing 210 of FIG. 2A) moves relative to another housing (e.g., the second housing 220 of FIG. 2A). The various form factors may include a form factor operating in a rolling and/or bending manner in addition to a form factor operating in a folding manner.

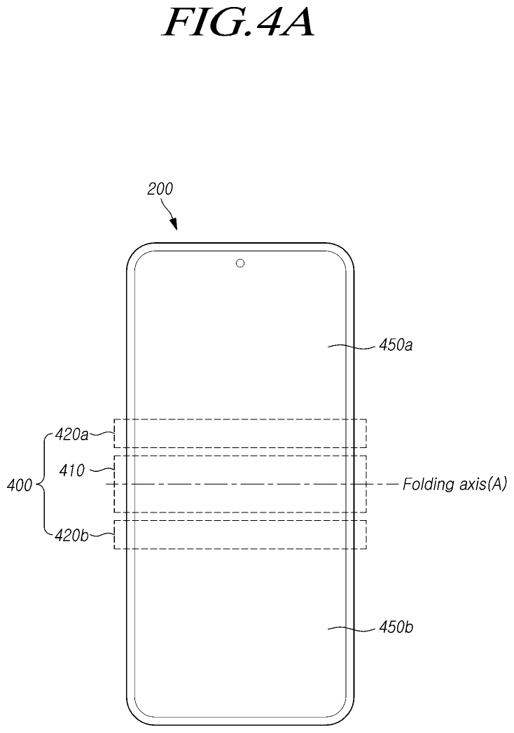

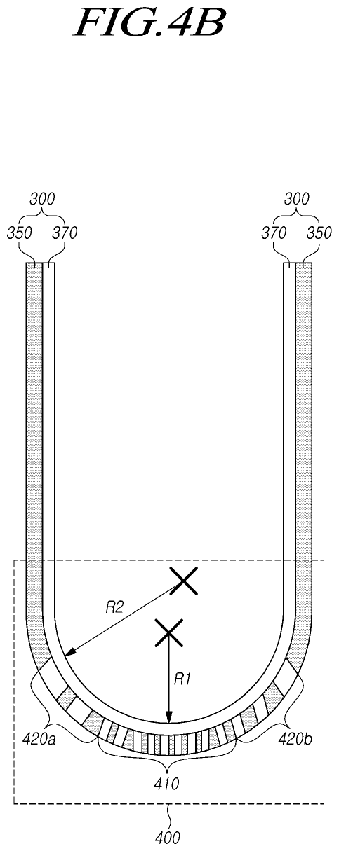

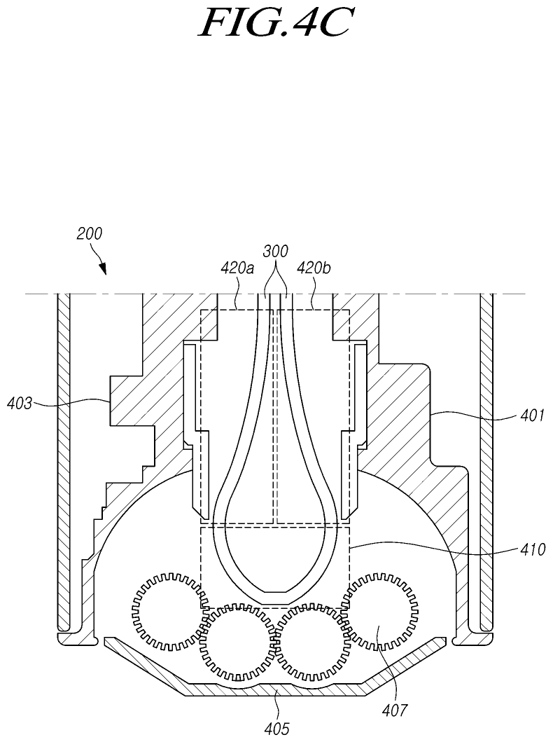

The display 299 may include a folding portion (or folding part) (e.g., the folding region 400 of FIG. 4A) and a flat portion (or non-folding portion) (e.g., the first and second flat regions 450a, 450b of FIG. 4A). The folding region 400 and/or the flat portion 450a, 450b may be configured in various forms and/or numbers according to a form factor of the electronic device 200 to which the flexible display is to be mounted. The folding region 400 may refer to a bending region according to the electronic device 200. The flat portion 450a, 450b may refer to a flat region other than the folding region 400, which maintains a flat surface during bending.

The display 299 may include a panel layer 310, a printing layer 320, a polymer layer 330, an adhesive layer 340, 360, a glass layer 350, or a protective layer 370. The layers constituting the display 299 may be stacked in a Z-axis direction. The layers are not limited to the illustrated order, and a stacking order may be changed as needed. Further, some of the layers may be omitted, or other layers not illustrated may be added. Further, the layers may have a predetermined thickness. Not limited to what is illustrated, the layers may have a differential thickness corresponding to the folding region 400 and/or the flat portion 450a, 450b. In this regard, a cross-sectional view illustrating the stacked structure of the display 299 is described below.

One of the layers may be implemented as a combination of identical or different layers. As an example, the adhesive layer 340, 360 is not limited to what is illustrated, and may be disposed between layers to form a stacked structure. As an example, the protective layer 370 may also be implemented as a combination of a coating layer (e.g., the coating layer or the film layer 370 of FIG. 4B).

The configuration illustrated in FIG. 3 is merely exemplary for convenience of description, and the display 299 may include at least one additional configuration. For example, a polarizer (e.g., polarizing film) and/or a touch sensing layer may be provided between the panel layer 310 and the printing layer 320. The touch sensing layer may be configured to obtain coordinate information of an external input. The touch sensing layer may be, e.g., a capacitive touch sensing member. However, without limitations thereto, may be redisposed with another type of touch sensing layer including two types of touch electrodes, such as an electromagnetic induction type.

The panel layer 310 may be disposed below the glass layer 350. The panel layer 310 may be a display panel, such as an organic light emitting display panel, an electrophoretic display panel, an electrowetting display panel, or a quantum dot display panel, but the type thereof is not limited. A light emitting layer of the organic light emitting display panel may include an organic light emitting material. A light emitting layer of the quantum dot display panel may include a quantum dot and a quantum rod. The panel layer 310 may be formed to be at least partially bendable. For example, the panel layer 310 may be formed to be at least partially deformable.

The glass layer 350 may be disposed on the panel layer 310. The glass layer 350 may be stacked to directly contact the panel layer 310. However, without limitations thereto, another type of layer, such as a polarizing layer or a touch sensing layer, although not illustrated, may be provided between the glass layer 350 and the panel layer 310. The glass layer 350 may be described as a glass member.

The glass layer 350 may be provided to prevent the panel layer 310 from being damaged due to external impact. The glass layer 350 may allow light according to a screen displayed on the panel layer 310 to be transmitted therethrough while mitigating transmission of external impact to the panel layer 310. Here, the external impact may be a force applied from the outside, such as pressure or stress.

The glass layer 350 may be including ultra-thin glass (UTG) or polyimide (PI). The glass layer 350 may have a predetermined transmittance or transparency. The glass layer 350 may have a predetermined thickness. As an example, the glass layer 350 may have a thickness determined within a range of 20 μm (micrometer) to 150 μm. As an example, the glass layer 350 may have a thickness determined within a range of 50 μm to 500 μm. However, without limitations thereto, may have a predetermined thickness corresponding to a structure of the display 299. The glass layer 350 may have a differential thickness in which a thickness of the folding region 400 and a thickness of the flat portion 450a, 450b are different. A glass having the differential thickness may be referred to as a “variable thickness glass (VTG).” The glass layer 350 may have, e.g., a thickness of the folding region 400 relatively thinner than a thickness of the flat portion 450a, 450b. This may enhance a flexible characteristic of the folding region 400 while enhancing durability of the flat portion 450a, 450b.

The printing layer 320 may be disposed in at least a partial region of the display 299. The printing layer 320 may be disposed, e.g., near an edge of the glass layer 350. The printing layer 320 may be disposed on an upper surface (upper side) or a lower surface (lower side) of the glass layer 350. The printing layer 320 may be disposed along an edge of the glass layer 350. The printing layer 320 may be disposed along a border of the glass layer 350. The printing layer 320 may be disposed by being impregnated or penetrated into the upper surface of the glass layer 350.

The printing layer 320 may be disposed on one surface (e.g., lower surface) of the polymer layer 330 provided below the first adhesive layer 340. To this end, the display 299 may further include the polymer layer 330. The polymer layer 330 may be including a polymer material having a predetermined hardness. The polymer material may be, e.g., one or a composite of polyethylene terephthalate (PET), polyimide (PI), or thermoplastic polyurethane (TPU). In case that the printing layer 320 is disposed on the lower surface of the polymer layer 330, the printing layer 320 may be stably disposed due to a predetermined hardness of the polymer layer 330.

The printing layer 320 may be a border of a display region viewed from the outside in case that the display 299 is disposed in the electronic device 200. The printing layer 320 may be formed along a border portion of the glass layer 350, but the disclosure is not limited thereto. The printing layer 320 may form, e.g., a bezel pattern. The printing layer 320 may be including a light-blocking material through which light is not transmitted. The printing layer 320 may be disposed to overlap at least a partial region with the display region of the display 299 viewed from the outside. The printing layer 320 may be disposed such that at least a portion thereof is visible from the outside. The printing layer 320 may have a predetermined thickness. The printing layer may have, e.g., a width of 1 mm or less, but the disclosure is not limited thereto.

The first or second adhesive layer 340, 360 may include at least one of an optically clear adhesive film (OCA), an optically clear resin (OCR), a pressure sensitive adhesive film (PSA), a thermally reactive adhesive, a general adhesive, or a double-sided tape. The first or second adhesive layer 340, 360 includes a light-curing adhesive material or a heat-curing adhesive material, and the material thereof is not particularly limited. The first adhesive layer 340 may bond between the glass layer 350 and the polymer layer 330 or between the glass layer 350 and the printing layer 320. The second adhesive layer 360 may bond between the glass layer 350 and the protective layer 370.

A first region 341 included in the first adhesive layer 340 may be including a soft low-modulus material. A second region 343 included in the first adhesive layer 340 may be including a hard high-modulus material. The first region 341 may have a first modulus value. The second region 343 may have a second modulus value. The second modulus value may be a relatively higher value than the first modulus value. Here, the first region 341 and/or the second region 343 may be understood as a region occupied by an adhesive of a low-modulus material and/or a region occupied by an adhesive of a high-modulus material, rather than a predetermined specific space. The low-modulus material and/or the high-modulus material may be implemented by a characteristic of a monomer forming a polymer or a molecular structure constituting the material. Due to modulus characteristics of the first region 341 and the second region 343, rigidity of the second region 343 may be relatively higher than that of the first region 341.

The first region 341 and/or the second region 343 may correspond to at least a portion of the glass layer 350. The first region 341 and the second region 343 may be disposed below the glass layer 350. The second region 343 may be provided around the first region 341 to form a border of the first adhesive layer 340. The first region 341 and the second region 343 may have various arrangement structures corresponding to a variable shape of the display 299.

The first region 341 may reduce an external force (e.g., a repulsive force generated by tension and/or contraction of the folding region 400) generated in response to a shape of the display 299 being deformed. The second region 343 may provide a region for the printing layer 320 to be disposed on one surface of the first adhesive layer 340. The printing layer 320 may be disposed below the second region 343. In case that the second region 343 has a modulus characteristic equal to or greater than a threshold level, printing precision and/or printing quality of the printing layer 320 may be enhanced.

The protective layer 370 may be disposed as an uppermost layer of the display 299. The protective layer 370 may be disposed above the glass layer 350 to protect the glass layer 350. In case that the glass layer 350 is damaged, the protective layer 370 may reduce scattering of glass pieces separated from the glass layer 350.

The protective layer 370 may be including one or more layers. The protective layer 370 may include, e.g., a first protective layer (or coating layer) or a second protective layer (or film layer). The first protective layer and the second protective layer may be stacked. The first protective layer and the second protective layer may be stacked to constitute one protective layer 370, or the first protective layer and the second protective layer may be configured as separate protective layers.

The first protective layer may be including a material having a predetermined hardness for protection of the display 299, particularly the glass layer 350. The first protective layer may be including a material providing anti-fingerprint performance to prevent or reduce occurrence of fingerprint traces generated in response to operation of the display 299.

The second protective layer may be including a material having a predetermined hardness for protection of the display 299. The second protective layer may be including a polymer material. The polymer material may include, e.g., PET, PI, or TPU. The second protective layer may have a predetermined thickness. The printing layer 320 may also be disposed on one surface of the second protective layer.

The printing layer 320 may be disposed on one surface of the second protective layer. In this case, the second protective layer may be provided below the first adhesive layer 340. The printing layer 320 may be disposed on a lower surface of the second protective layer. For the printing layer 320 to be stably disposed on the lower surface of the second protective layer, the second protective layer may have a predetermined hardness.

The protective layer 370 may be disposed above the glass layer 350. To be disposed above the glass layer 350, the protective layer 370 may be coated on an upper surface of the glass layer 350, or may be bonded by an adhesive layer (e.g., the second adhesive layer 360). The protective layer 370 may be coated on the upper portion of the glass layer 350 to have a predetermined thickness. For the protective layer 370 to be disposed on the upper surface of the glass layer 350, the second adhesive layer 360 may be provided between the protective layer 370 and the glass layer 350.

The display 299 is not limited to the illustrated stacked structure, and layers may be disposed in various orders. As an example, the display 299 may be stacked in an order of the panel layer 310, the first adhesive layer 340, the glass layer 350, the printing layer 320, and the protective layer 370. As an example, the display 299 may be stacked in an order of the panel layer 310, the printing layer 320, a film layer, the glass layer 350, and a coating layer. In this case, the printing layer 320 may be disposed on a lower surface of a member having a predetermined hardness. To this end, the protective layer 370 or the film layer having a predetermined hardness needs to be provided on an upper surface of the printing layer 320.

FIG. 4A is a plan view illustrating a flexible display (e.g., the display 140 of FIG. 1 or the display 299 of FIGS. 2A, 2B, 2C, 2D, 2E, and 2F) including a folding region in an electronic device (e.g., the electronic device 100 of FIG. 1 or the electronic device 200 of FIGS. 2A, 2B, 2C, 2D, 2E, and 2F) according to an embodiment of the disclosure. FIG. 4B is a side cross-sectional view illustrating a display protective member (e.g., the display protective member 300 of FIG. 3) included in a flexible display (e.g., the display 140 of FIG. 1 or the display 299 of FIGS. 2A, 2B, 2C, 2D, 2E, and 2F) in an electronic device (e.g., the electronic device 100 of FIG. 1 or the electronic device 200 of FIGS. 2A, 2B, 2C, 2D, 2E, and 2F) according to an embodiment of the disclosure. FIG. 4C is an enlarged cross-sectional view illustrating a hinge portion (e.g., the hinge assembly 240 of FIG. 2F) for folding of a flexible display (e.g., the display 140 of FIG. 1 or the display 299 of FIGS. 2A, 2B, 2C, 2D, 2E, and 2F) in an electronic device (e.g., the electronic device 100 of FIG. 1 or the electronic device 200 of FIGS. 2A, 2B, 2C, 2D, 2E, and 2F) according to an embodiment of the disclosure.

Referring to FIGS. 4A and 4B, a folding region 400 of a display protective member 300 may include a first folding region 410 and/or a second folding region 420a, 420b. A first folding region 410 may be provided near a center of a region where an electronic device 200 is folded about a folding axis. The second folding region 420a, 420b may be provided near a periphery of the first folding region 410 about the folding axis.

During folding of the electronic device 200, a radius of curvature R1 of the first folding region 410 may be smaller than a radius of curvature R2 of the second folding region 420a, 420b. For example, the folding region 400 may be folded along a curve that is not a circular arc (e.g., a curve extending in a length direction (y direction in FIG. 4B), such as elliptical, parabolic, hyperbolic, or similar). In case that the folding region 400 is folded along the above-described curve, a thickness of the electronic device 200 in the folded state may be decreased.

To reduce the thickness of the electronic device 200 in the folded state, it is preferable to reduce a radius of curvature of the folding region 400. In case that the radius of curvature is decreased, an area of the folding region 400 may be decreased. In case that the area of the folding region 400 is excessively decreased, a bending moment applied by folding is concentrated on a narrow portion of the folding region 400, and the display protective member 300 may be damaged. Since the folding region 400 includes the first folding region 410 folded with a relatively small radius of curvature R1 and the second folding region 420a, 420b bent with a relatively large radius of curvature, a portion of the bending moment applied to the first folding region 410 may be distributed to the second folding region 420a, 420b. In this case, a risk of damage to the display protective member 300 may be decreased.

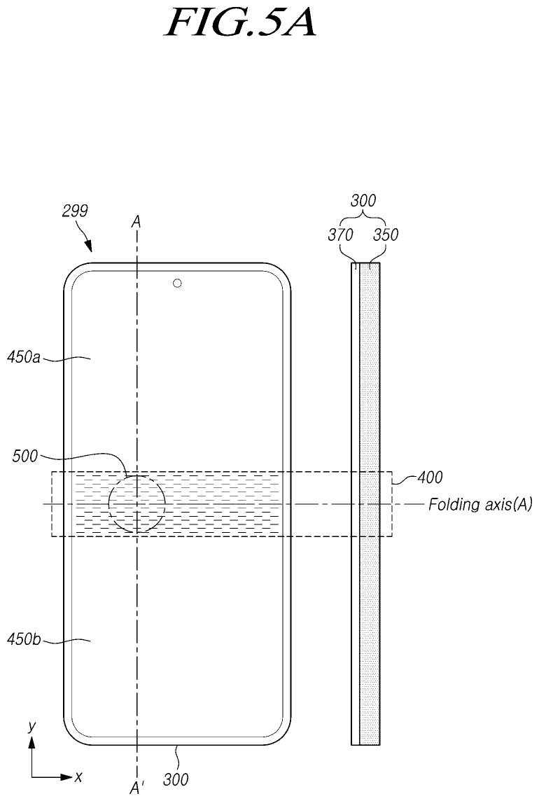

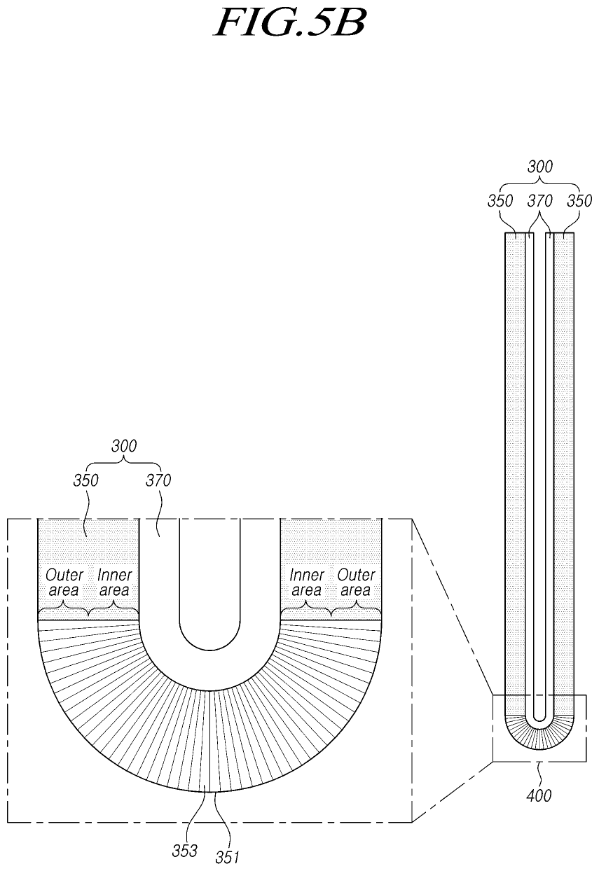

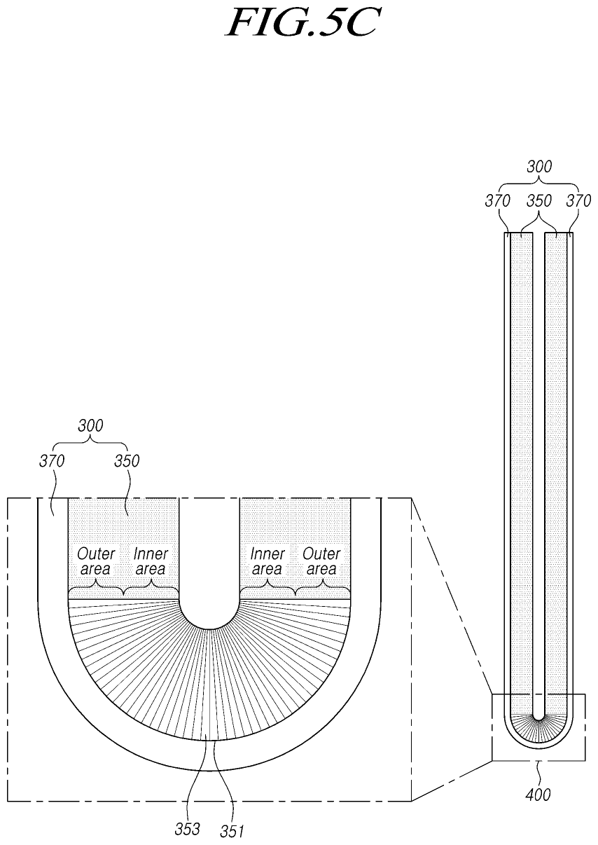

For the second folding region 420a, 420b to be folded with a larger radius of curvature than the first folding region 410, a width of a through hole (e.g., the slit 351 of FIG. 5B or 5C) and/or a width of a rib (e.g., the rib 353 of FIG. 5B or 5C) of the second folding region 420a, 420b may be larger than that of the first folding region 410. The effect of the width of the slit 351 and/or the rib 353 on the radius of curvature where the folding region 400 is folded is as described above.

Referring to FIG. 4C, an electronic device 200 may include a first folding region 410 that is in-folded and a second folding region 420a, 420b that is out-folded in case that the folding region 400 is folded. A folding shape in which a region adjacent to a center of the folding region 400 is in-folded and a peripheral portion is out-folded about the folding axis may be referred to as waterdrop shaped folding. The first folding region 410 may have a configuration suitable for in-folding, e.g., a width of the slit 351 and/or the rib 353 may be relatively small. The second folding region 420 may have a configuration suitable for out-folding, e.g., a width of the slit 351 and/or the rib 353 may be relatively large. Taper directions of the slit 351 in the first folding region 410 and/or the second folding region 420a, 420b may be opposite to each other. For example, the slit 351 of the first folding region 410 may have an in-folding type taper direction. The slit 351 of the second folding region 420a, 420b may have an out-folding type taper direction. During the waterdrop shaped folding, end portions of the second folding region 420a, 420b may be adjacent to each other or may contact each other. In this case, a thickness of the electronic device 200 in the folded state may be decreased.

FIG. 5A is a view illustrating folding region (e.g., the folding region 400 of FIGS. 4A, 4B, and 4C) provided based on a folding axis (e.g., the folding axis A of FIGS. 4A, 4B, and 4C) for a folding operation in an electronic device (e.g., the electronic device 100 of FIG. 1 or the electronic device 200 of FIGS. 2A, 2B, 2C, 2D, 2E, and 2F) according to an embodiment of the disclosure. FIG. 5B or 5C is a side view illustrating a folding operation of a display protective member (e.g., the display protective member 300 of FIG. 3) according to various embodiments of the disclosure.

Referring to FIGS. 5A, 5B, and 5C, a display protective member 300 may be folded in a folding region 400 about a folding axis A. The display protective member 300 may have a structure in which a protective layer 370 (e.g., the protective layer 370 of FIG. 3) is stacked on a glass layer 350 (e.g., the glass layer 350 of FIG. 3). As an example, the display protective member 300 may be folded in an in-folding manner in which an upper portion is located on an inner side of a curved surface based on a direction in which a flexible display (e.g., the display 140 of FIG. 1 or the display 299 of FIGS. 2A, 2B, 2C, 2D, 2E, and 2F) displays an image (see FIG. 5B). As an example, a display protective member 300 may be folded in an out-folding manner in which an upper portion is located on an outer side of a curved surface based on a direction in which a flexible display 299 displays an image (see FIG. 5C).

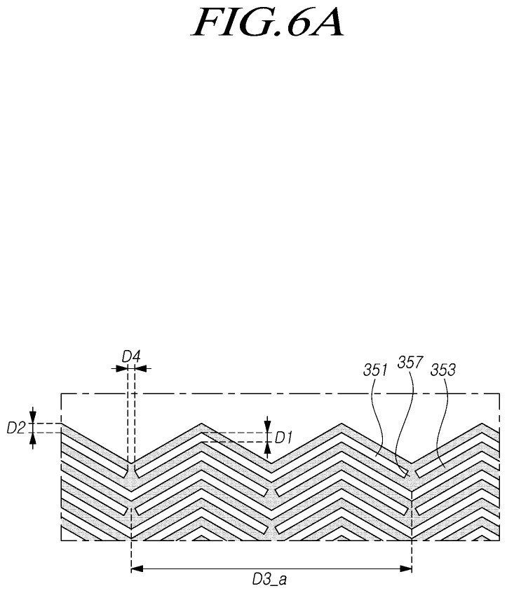

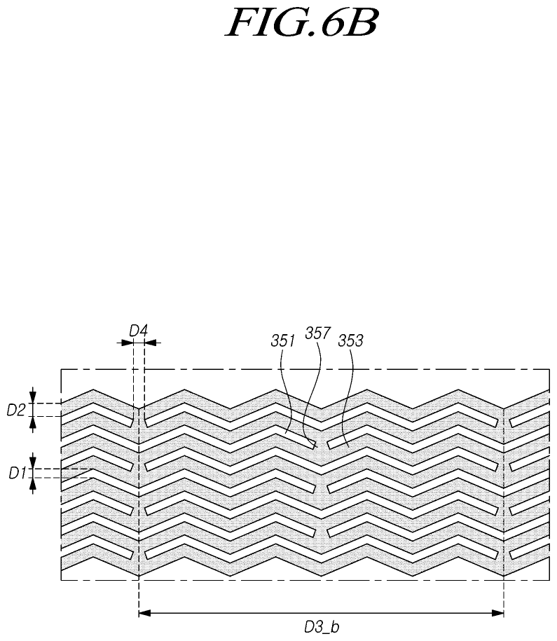

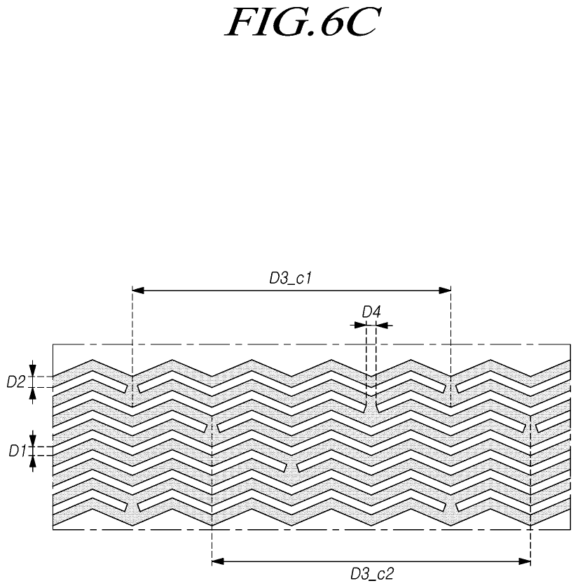

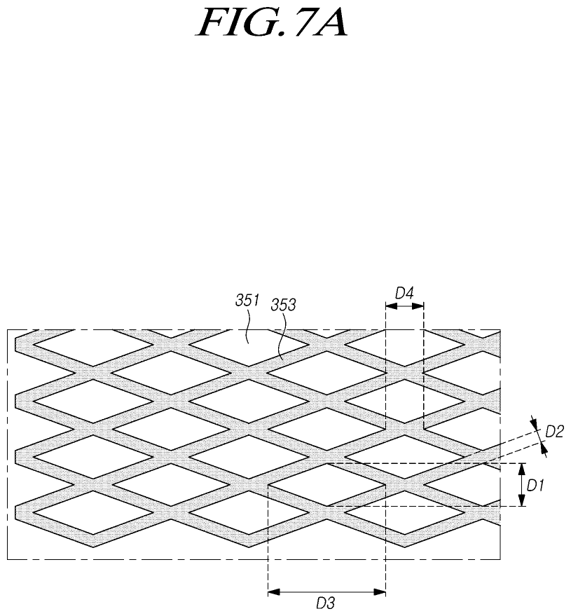

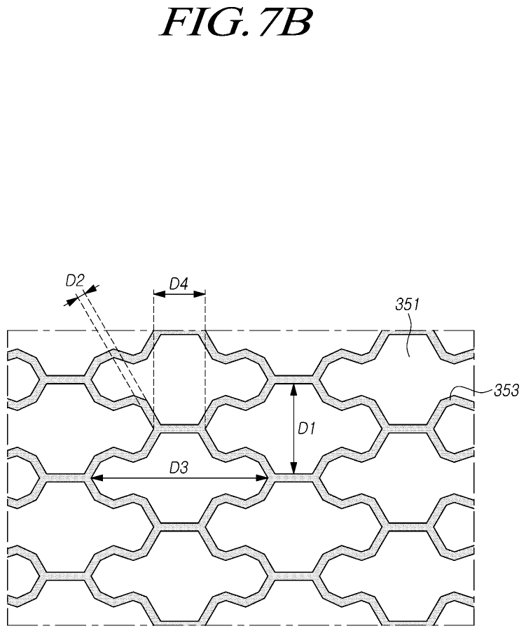

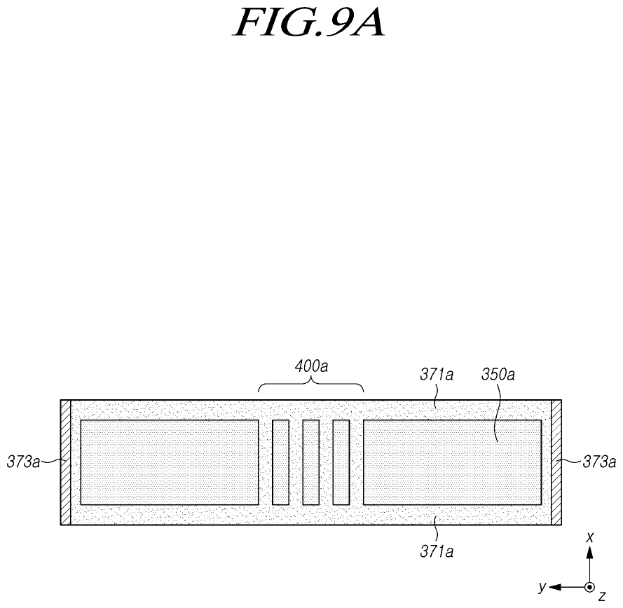

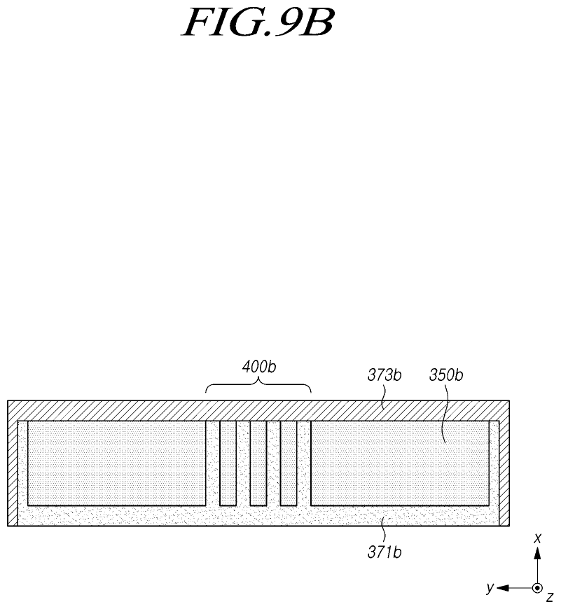

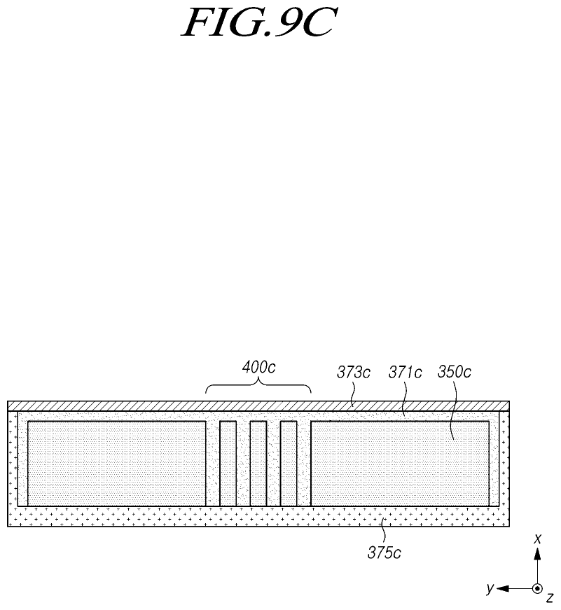

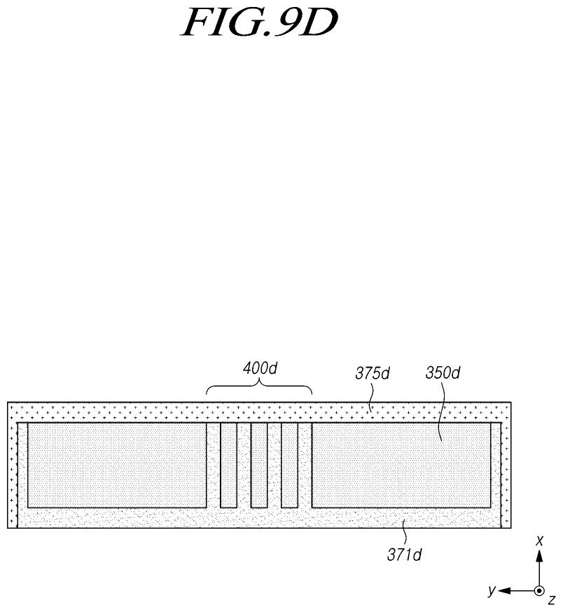

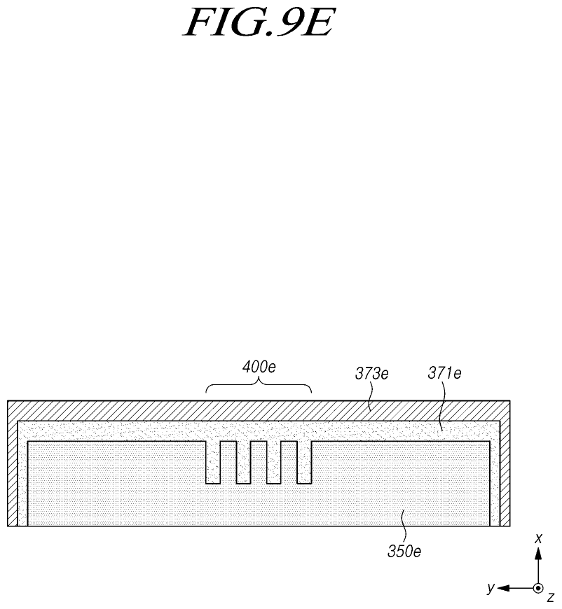

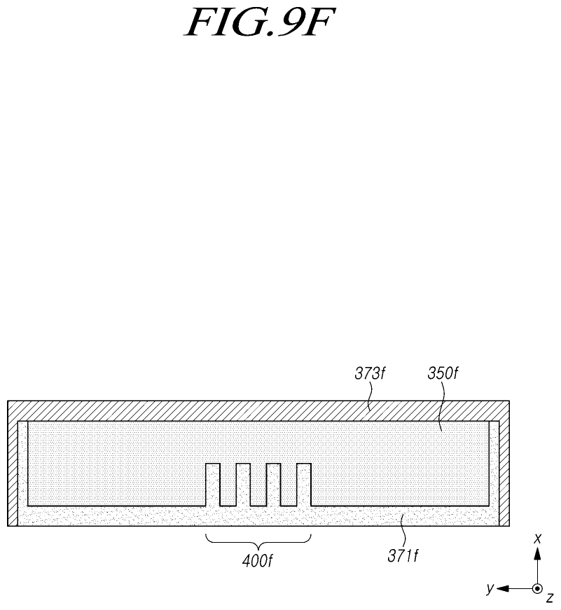

For the display protective member 300 to be foldable, a slit 351 (e.g., through hole) and/or a rib 353 (e.g., the rib 353 of FIGS. 6A, 6B, and 6C, FIG. 7A, or 7B, or the rib of FIG. 9E or 9F) based on a predetermined pattern (e.g., FIGS. 6A, 6B, and 6C, FIG. 7A, or 7B) may be included in the folding region 400 of the glass layer 350 (e.g., the glass layer 350 of FIG. 3). The slit 351 may be a hole (e.g., a slit 351 of FIGS. 6A, 6B, and 6C, FIG. 7A, or 7B) formed to penetrate the glass layer 350 based on a predetermined pattern (e.g., a through pattern) in the folding region 400. The slit 351 may be a groove (e.g., a recess of FIG. 9E or 9F) recessed to a predetermined depth in the glass layer 350 in a predetermined pattern (e.g., a non-through pattern) in the folding region 400. In the following description, a through hole or a recess formed in the glass layer 350 is collectively referred to as a ‘slit 351.’ A predetermined pattern (e.g., FIG. 6A, FIG. 6B or 6C, FIG. 7A or 7B) that may be considered for forming the slit 351 in the folding region 400 of the glass layer 350 may be a pattern configured to have buckling stability. The buckling free pattern may be a pattern designed to increase a buckling critical external force. The buckling free pattern may have, e.g., a side low-hardness stretch polymer (e.g., transparent adhesive (optically clear resin (OCR))) protective coating structure. The predetermined pattern may be, e.g., a chevron shape. The chevron shape may be a shape in which a straight line is bent at a predetermined angle several times in a symmetric direction (e.g., up and down direction) (e.g., see FIG. 6A, FIG. 6B or 6C). The chevron shape may be a ‘¬’ shape or a ‘∧’ shape (hereinafter referred to as a ‘V shape’) or a shape in which ‘∧’ is repeated (hereinafter referred to as a ‘W’ shape). A pattern including the repeated V shape or the W shape may be a pattern in which a moire phenomenon does not occur within a limit of repulsive force. The moire phenomenon refers to a phenomenon in which a peculiar wave pattern appears on a display. The moire phenomenon may occur in case that a size of a repeated pattern is dense and an image sensor may not distinguish it. As an example, a pattern including the repeated V shape or the W shape in which the moire phenomenon does not occur may have an angle range determined between 0 degrees and 50 degrees.

The slit 351 may be provided between the ribs 353. In other words, the slit 351 and the rib 353 may be alternately disposed. As an example, the rib 353 may be provided along both edge lines of the slit 351. In this case, the rib 353 may have the same pattern shape as the slit 351. The slit 351 may be filled with a material having a relatively lower modulus than the protective layer 370. This may enhance flexibility of the folding region 400 corresponding to a folding portion of the flexible display 299.

In case that the display protective member 300 is folded, the folding region 400 may be elastically deformed. This may deform a shape of the slit 351. In case that the rib 353 is deformed by compressive stress, a width A1 of the slit 351 may be decreased in an inner area located on an inner side based on a folded state of the display protective member 300. In case that the rib 353 is deformed by tensile stress, a width A2 of the slit 351 may be increased in an outer area located on an outer side based on the folded state of the display protective member 300. According to deformation of the slit 351, a shape of a soft polymer filling an inside of the slit 351 may also be changed. Due to the presence of the slit 351 and elastic deformation of the soft polymer filling the inside of the slit 351, the glass layer 350 may be folded together with the flexible display 299. In other words, the glass layer 350 may have a sufficient thickness to achieve structural rigidity capable of preventing deformation due to external pressure, while having flexibility to be foldable in the folding region 400.

An amount of elastic deformation required for the rib 353 and/or the slit 351 in the folding region 400 may vary according to a radius of curvature in case that the display protective member 300 is folded. For example, in case that the radius of curvature is large, a relatively small elastic deformation may be applied to the folding region 400. For example, in case that the radius of curvature is small, a relatively large elastic deformation may be applied to the folding region 400.

For the folding region 400 to have flexibility, an elastic modulus of the soft polymer material may be 1 to 1000 kPa. In case that the elastic modulus exceeds 1000 kPa, rigidity of the soft polymer region is excessively high, and sufficient elastic deformation for the folding region 400 to be folded may not occur. In case that the elastic modulus is less than 1 kPa, strength of the soft polymer region is low, and the soft polymer material may be permanently deformed in case that the folding region 400 is folded, or the soft polymer material may be pushed out of the slit 351, which may damage the display protective member 300.

FIGS. 6A, 6B, and 6C are enlarged plan views illustrating a partial region (e.g., the selection region 500 of FIG. 5A) in a folding region (e.g., the folding region 400 of FIGS. 4A, 4B, and 4C) included in a glass layer (e.g., the glass layer 350 of FIGS. 2A, 2B, 2C, 2D, 2E, and 2F) of a flexible display (e.g., the display 140 of FIG. 1 or the display 299 of FIGS. 2A, 2B, 2C, 2D, 2E, and 2F) according to various embodiments of the disclosure.

Referring to FIG. 6A, dimensions, such as a slit width D1 of the slit 351, a rib width D2 of the rib 353, a slit height D3_a, or a bridge width D4 of the bridge 357 may be determined for the folding region 400 according to a design of an electronic device (e.g., the electronic device 100 of FIG. 1 or the electronic device 200 of FIG. 2). As the slit width D1 of the slit 351 and the rib width D2 of the rib 353 decrease, flexibility of the folding region 400 increases and elastic repulsive force decreases. Further, as the slit height D3_a increases, the flexibility of the folding region 400 may increase. As the bridge width D4 of the bridge 357 decreases, the flexibility of the folding region 400 may increase.

According to an example, in case that the electronic device 200 is designed such that the folding region 400 is folded with a high radius of curvature, in the electronic device 200 of the out-folding type (e.g., FIG. 5C), since an amount of elastic deformation required for the folding region 400 is relatively low, widths of the slit 351 and the rib 353 of the folding region 400 may be set large.

According to an example, in case that the electronic device 200 is designed such that the folding region 400 is folded with a low radius of curvature, in the electronic device 200 of the in-folding type (e.g., FIG. 5B), since a high amount of elastic deformation is required for the folding region 400, widths of the slit 351 and the rib 353 may be set small.

A shape of the slit 351 may extend in a length direction, i.e., a direction parallel to the folding axis A (x-axis direction in FIG. 5A). The slit 351 may have a shape in which inner surfaces facing each other are substantially parallel. As an example, a rib 353 and a slit 351 of a specific pattern may repeatedly extend in a direction parallel to the folding axis A in a folding region 400 provided corresponding to the folding region 400 in the glass layer 350. A slit length D3_a corresponding to a distance between a first bridge corresponding to a start point of the slit 351 and a second bridge corresponding to an end point of the slit 351 may be determined based on at least one of a thickness of the glass layer 350 or a modulus of a polymer filling the slit 351. The first bridge and the second bridge may be configured to connect a first rib and a second rib disposed in parallel on two opposite sides of the slit 351 to cross the rib 353 substantially perpendicular to the folding axis A.

As an example, the slit 351 may have a wave shape or a chevron shape. The wave shape or the chevron shape may have a specific pattern bent with respect to a width direction of the slit 351, i.e., a direction perpendicular to the folding axis A on a surface of the glass layer 350. As an example, the specific pattern may be a V shape. The V-shaped slit 351 or rib 353 may be extended by continuous repetition in a direction parallel to the folding axis A (x-axis direction in FIG. 5A). The wave shape may have higher flexibility than a substantially straight shape. The V-shaped slit 351 or rib 353 may be repeated a predetermined number of times within the slit length D3_a. The slit length may be determined based on at least one of a width or a number of repetitions of the V-shaped specific pattern. For example, the slit length may become 4 mm by repeating one V pattern having a width of 1 mm four times. In this case, it may be advantageous for reaction force, but visibility may be disadvantageous according to the shape. For example, the slit length may also become 4 mm by repeating one V pattern having a width of 2 mm two times. In this case, it may be advantageous for visibility according to the shape, but may be disadvantageous for reaction force. Therefore, a pattern for repetition may be selected as needed considering desired characteristics. The predetermined number of times may be two. However, a repetition pattern of two times may reduce randomness of a position of the bridge 357, but may enhance rigidity of the glass layer 350.

According to an example, a plurality of slits and a plurality of ribs may extend in a direction perpendicular to the folding axis A in the folding region 400. Start points and end points of odd-numbered slits included in the plurality of slits may be disposed to coincide in a perpendicular direction, e.g., at a first position of the folding axis A. In this case, bridges 357 crossing the odd-numbered slits may be disposed in a line in the perpendicular direction of the folding axis A. Start points and end points of even-numbered slits included in the plurality of slits may be disposed to coincide in a perpendicular direction, e.g., at a second position of the folding axis A. In this case, bridges 357 crossing the even-numbered slits may be disposed in a line in the perpendicular direction of the folding axis A.

Referring to FIG. 6B, dimensions, such as a slit width D1 of the slit 351, a rib width D2 of the rib 353, a slit height D3_b, or a bridge width D4 of the bridge 357 may be determined for the folding region 400 according to a design of an electronic device (e.g., the electronic device 100 of FIG. 1 or the electronic device 200 of FIG. 2). As the slit width D1 of the slit 351 and the rib width D2 of the rib 353 decrease, flexibility of the folding region 400 increases and elastic repulsive force decreases. Further, as the slit height D3_b increases, the flexibility of the folding region 400 may increase. Therefore, the folding region 400 of the pattern illustrated in FIG. 6B may ensure relatively higher flexibility than the folding region 400 of the pattern illustrated in FIG. 6A. As the bridge width D4 of the bridge 357 decreases, the flexibility of the folding region 400 may increase.

The slit 351 may have a wave shape or a chevron shape. The wave shape or the chevron shape may have a specific pattern bent with respect to a width direction of the slit 351, i.e., a direction perpendicular to the folding axis A on a surface of the glass layer 350. As an example, the specific pattern may be a V shape. The V-shaped slit 351 or rib 353 may be extended by continuous repetition in a direction parallel to the folding axis A (x-axis direction in FIG. 5A). The V-shaped slit 351 or rib 353 may be repeated a predetermined number of times within the slit length D3_b. The predetermined number of times may be three or more.

Referring to FIG. 6C, dimensions, such as a slit width D1 of the slit 351, a rib width D2 of the rib 353, a first slit height D3_c1, a second slit height D3_c2, or a bridge width D4 of the bridge 357 may be determined for the folding region 400 according to a design of an electronic device (e.g., the electronic device 100 of FIG. 1 or the electronic device 200 of FIG. 2).

Start points and end points of odd-numbered slits included in a plurality of slits extending in a direction perpendicular to the folding axis A in the folding region 400 may be disposed to coincide in a perpendicular direction at a first position of the folding axis. The first slit height D3_c1 may be a length between the start points and the end points of the odd-numbered slits. Start points and end points of even-numbered slits included in a plurality of slits extending in a direction perpendicular to the folding axis A in the folding region 400 may be disposed to coincide in a perpendicular direction at a second position of the folding axis. The second slit height D3_c2 may be a length between the start points and the end points of the odd-numbered slits. The first slit height D3_c1 and the second slit height D3_c2 may be the same.

As the slit width D1 of the slit 351 and the rib width D2 of the rib 353 decrease, flexibility of the folding region 400 increases and elastic repulsive force decreases. Further, as the first slit height D3_c1 or the second slit height D3_c2 increases, the flexibility of the folding region 400 may increase. Therefore, the folding region 400 of the pattern illustrated in FIG. 6C may ensure relatively higher flexibility than the folding region 400 of the pattern illustrated in FIG. 6A. As the bridge width D4 of the bridge 357 decreases, the flexibility of the folding region 400 may increase.

According to an example, a plurality of slits and a plurality of ribs may extend in a direction perpendicular to the folding axis A in the folding region 400. Start points and end points of the plurality of slits may be disposed to be offset, e.g., in the perpendicular direction of the folding axis A. In other words, bridges 357 crossing the plurality of slits 351 may be randomly shuffled on the folding axis A.

According to an example, in the patterns illustrated in FIGS. 6A, 6B, and 6C, the slit width D1 of the slit 351, the rib width D2 of the rib 353, the slit height D3_a, D3_b, D3_c1, or D3_c2, or the bridge width D4 of the bridge 357 may be determined based on a thickness of the glass layer 350. For example, in case that the thickness of the glass layer 350 increases, the slit height D3_a, D3_b, D3_c1, or D3_c2 may become longer in proportion to the increase in the thickness of the glass layer 350.

According to an example, in the patterns illustrated in FIGS. 6A, 6B, and 6C, the slit width D1 of the slit 351, the rib width D2 of the rib 353, the slit height D3_a, D3_b, D3_c1, or D3_c2, or the bridge width D4 of the bridge 357 may be determined based on a modulus of a polymer filling the slit 351. For example, in case that the modulus (or elastic modulus) of the polymer filling the slit 351 increases, the slit height D3_a, D3_b, D3_c1, or D3_c2 may become longer in proportion to the increase in the modulus (or elastic modulus).

According to an example, in the patterns illustrated in FIGS. 6A, 6B, and 6C, the slit width D1 of the slit 351, the rib width D2 of the rib 353, the slit height D3_a, D3_b, D3_c1, or D3_c2, or the bridge width D4 of the bridge 357 may be determined based on at least one of the thickness of the glass layer 350 or the modulus of the polymer filling the slit 351.

According to an example, in the patterns illustrated in FIGS. 6A, 6B, and 6C, the slit width D1 of the slit 351, the rib width D2 of the rib 353, the slit height D3_a, D3_b, D3_c1, or D3_c2, or the bridge width D4 of the bridge 357 may be determined based on the thickness of the glass layer 350 and the modulus of the polymer filling the slit 351. For example, the slit height D3_a, D3_b, D3_c1, or D3_c2 may be determined by considering together a degree of increase in the thickness of the glass layer 350 and a degree of increase in the modulus (or elastic modulus) of the polymer filling the slit 351.

The following Table 1 illustrates an example of a slit length determined based on a thickness of the glass layer 350 and a modulus of a polymer filling the slit 351.

TABLE 1

| Glass layer thickness | Modulus of polymer filling slit | Slit length |
|---|---|---|
| 0.1 T | <1 MPa | 2 to 6 mm |
| | >1 MPa | 2 to 8 mm |
| 0.13 T | <1 MPa | 2 to 6 mm |
| | >1 MPa | 2 to 10 mm |
| 0.15 T | <1 MPa | 2 to 8 mm |
| | >1 MPa | 4 to 10 mm |
| 0.2 T | <1 MPa | 2 to 8 mm |
| | >1 MPa | 4 to 12 mm |

According to the Table 1, as an example, in case that a glass layer thickness (e.g., 0.15T) is fixed and, in case that a modulus of a polymer filling a slit is less than 1 megapascal (MPa) and in case that it exceeds 1 MPa, it may be identified that a slit length is determined in a range of 2 mm to 8 mm or determined in a range of 4 mm to 10 mm. As an example, in case that a modulus of a polymer filling a slit (e.g., less than 1 MPa) is fixed and, in case that a glass layer thickness is 0.1 T and in case that it is 0.13 T, it may be identified that a slit length is determined in the same range of 2 mm to 6 mm. As an example, in case that a modulus of a polymer filling a slit (e.g., exceeding 1 MPa) is fixed and, in case that a glass layer thickness is 0.1 T and in case that it is 0.15 T, it may be identified that a slit length is determined in a range of 2 mm to 8 mm or determined in a range of 4 mm to 10 mm. The shorter the length of the slit 351, the higher the rigidity of the glass layer 350. The thicker the glass layer 350, the longer the length of the slit 351 needs to be to reduce stress and reaction force acting on the glass layer 350 during bending. As an example, the higher the modulus of a polymer filling the slit 351, the longer the length of the slit 351 may be.

A relationship between the rib width D2 of the rib 353 and the bridge width D4 of the bridge 357 may affect peeling of the protective layer 370 or the glass layer 350 due to buckling. As an example, to prevent peeling of the protective layer 370 or the glass layer 350, the relationship between the rib width D2 of the rib 353 and the bridge width D4 of the bridge 357 should satisfy the requirements of the following Equation 1 or the following Equation 2.

$$\frac{B ridge Width}{Rib Width} < Th \# 1 \qquad Equation 1$$

$$\frac{Bridge Width}{Rib Width} \leq Th \# 1 \qquad Equation 2$$

In the Equation 1 or the Equation 2, a threshold Th #1 may be 0.5. This is because, in case that the bridge width D4 of the bridge 357 becomes half or less or less than half of the rib width D2 of the rib 353, a force applied to the bridge 357 may become greater than torsion of the rib 353. This may cause breakage of the bridge 357, and thus the width D4 of the bridge 357 should not become half or less or less than half of the width D2 of the rib 353. Therefore, to prevent breakage of the bridge 357, it may be preferable to design the width D2 of the rib 353 to be more than twice or at least twice the width D4 of the bridge 357. In other words, by creating a torsion effect such that torsion generated during bending acts relatively greater on the slit 351 than on the bridge 357, an overall reaction force may be decreased.

As an example, to prevent peeling of the protective layer 370 or the glass layer 350, it may be preferable to design such that a relatively greater torsion acts on the slit 351 than on the bridge 357 during bending. The following Equation 3 or the following Equation 4 defines a relationship between the slit width D1 of the slit 351 and the rib width D2 of the rib 353 such that a relatively greater torsion acts on the slit 351 than on the bridge 357 during bending.

$$\frac{Slit Width}{Rib Width} \leq Th \# 2 \qquad Equation 3$$

$$\frac{Slit Width}{Rib Width} \leq Th \# 2 \qquad Equation 4$$

In the Equation 3 or the Equation 4, a threshold Th #2 may be 1.2. This defines that, in case that the slit width D1 of the slit 351 is designed to exceed 1.2 times or be designed to be 1.2 times or more than the rib width D2 of the rib 353, there may be a high possibility of breakage of the bridge 357.

As an example, in case of configuring a folding portion (e.g., the folding region 400) such that the rib 353 has a relatively higher strength than a polymer filling the slit 351, a display protective member (e.g., the display protective member 300 of FIG. 3) may have a high rigidity, which is advantageous in terms of strength and may also enhance a glass feel.

FIG. 7A or 7B is a structure diagram illustrating a pattern glass in a folding region (e.g., the folding region 400 of FIGS. 4A, 4B, and 4C) of a flexible display (e.g., the display 140 of FIG. 1 or the display 299 of FIGS. 2A, 2B, 2C, 2D, 2E, and 2F) included in a glass layer (e.g., the glass layer 350 of FIGS. 2A, 2B, 2C, 2D, 2E, and 2F) according to various embodiments of the disclosure.

Referring to FIG. 7A, a slit 351 may have a rhombus shape. The rhombus shape has an advantage of allowing a width D1 of the slit 351 to be larger than a width D2 of the rib 353. As an example, a first layer may have a first pattern including a plurality of slits 351 or a plurality of recesses having the same shape (e.g., rhombus shape). The first pattern may include a first sub pattern in which a plurality of slits 351 are disposed at a 3-1 pitch P31 in a first direction (e.g., y-axis direction parallel to the folding axis A). The first pattern may include a second sub pattern in which a plurality of slits 351 are disposed at a 3-2 pitch P32 in a second direction perpendicular to the first direction.

According to an example, to reduce a moire phenomenon due to an effect of light between the first layer and a display (e.g., the display 140 of FIG. 1 or the display 299 of FIG. 2), a plurality of red subpixels, a plurality of green subpixels, or a plurality of blue subpixels included in the display 299 may be disposed to provide (or form) a pattern disposed at a pitch smaller than the 3-1 pitch P31 in substantially the same direction as a direction in which the plurality of slits 351 included in the first sub pattern of the first layer are disposed at the 3-1 pitch P31.

According to an example, to reduce a moire phenomenon due to an effect of light between the first layer and the display 299, a plurality of red subpixels, a plurality of green subpixels, or a plurality of blue subpixels included in the display 299 may be disposed to provide (or form) a pattern disposed at a pitch smaller than the 3-2 pitch P32 in substantially the same direction as a direction in which the plurality of slits 351 included in the second sub pattern of the first layer are disposed at the 3-2 pitch P32.

According to an example, to reduce a moire phenomenon due to an effect of light between the first layer and the display 299, edges of the plurality of slits 351 may be provided (or formed) to be substantially not parallel to arrangement directions of a plurality of subpixels included in the display 299, a second arrangement direction D2, a third arrangement direction D3, and a fourth arrangement direction D4. As an example, edges of the plurality of slits 351 may form a predetermined angle with the first to fourth arrangement directions D1, D2, D3, D4. The predetermined angle may have a range of, e.g., 7° to 38°.

Referring to FIG. 7B, a slit 351 may have a shape that is wavy in a width direction while having a generally rhombus shape. The wave shape has an effect of preventing stress from being concentrated on a specific portion of the rib 353.

As illustrated in FIG. 7A or 7B, even in case that a pattern shape changes, a hole-processed glass layer 350 may be including a structure in which ribs 353 are connected, i.e., a non-continuous lattice. In this case, it may be difficult to directly calculate a critical buckling load with a general Euler buckling load formula. Therefore, in case that the pattern shape changes, a critical buckling load may be calculated through computer simulation, and a structure having a high rigidity corresponding thereto may be designed.

The following Equation 5 defines an example of calculating a critical buckling load.

$${P}_{c r} = \frac{{π}^{2} E I}{{( {L}_{e} )}^{2}} = \frac{{π}^{2} E I}{{( K L )}^{2}} \qquad Equation 5$$

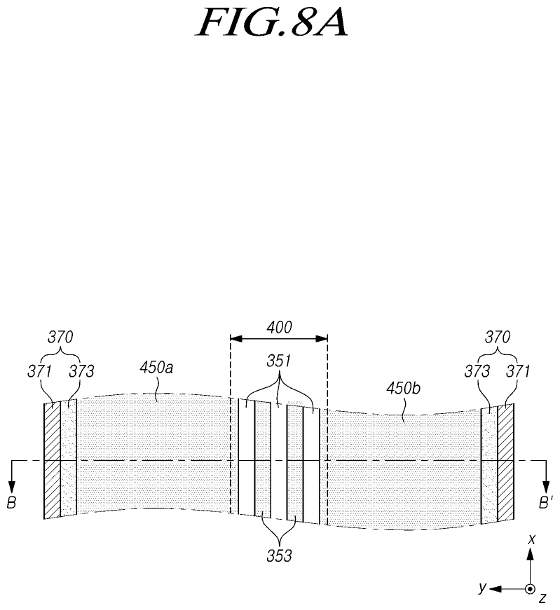

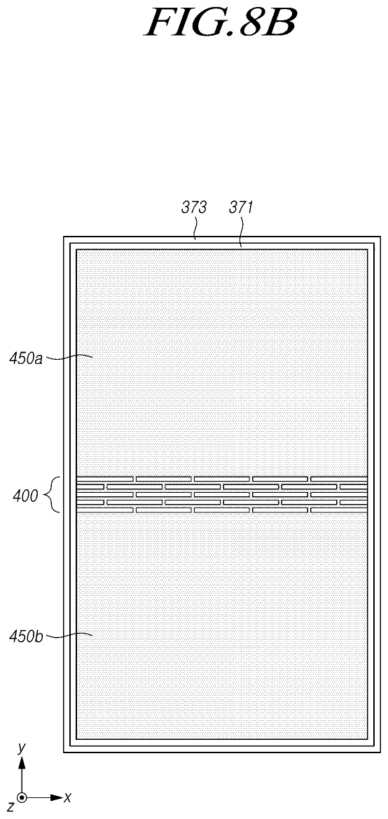

FIG. 8A is a side cross-sectional view (e.g., A-A′ of FIG. 5A) of a flexible display (e.g., the display 140 of FIG. 1 or the display 299 of FIGS. 2A, 2B, 2C, 2D, 2E, and 2F) according to an embodiment of the disclosure. FIG. 8B is a cross-sectional view as seen from a cutting line (B-B′) of FIG. 8A according to an embodiment of the disclosure.

Referring to FIGS. 8A, 8B, and 8C, a flexible display 299 may include a glass layer 350 (e.g., the glass layer 350 of FIG. 3) or a protective layer 370 (e.g., the protective layer 370 of FIG. 3). The protective layer 370 may be disposed as an uppermost layer of the flexible display 299. The protective layer 370 may be disposed to surround the glass layer 350 to protect the glass layer 350.

The protective layer 370 may be a coating layer formed of a material having a predetermined modulus. The coating layer may be an outer layer of an object coated with a thin film formed of a predetermined material, such as resin. The predetermined material forming the coating layer may be, e.g., a polymer. The polymer may have a predetermined modulus. The polymer may be a compound formed of molecules in which one type or several types of constituent units are polymerized to each other by many chemical bonds. The protective layer 370 may have a polymer coating structure.

The protective layer 370 may be including one or more layers. The protective layer 370 may include, e.g., a first protective layer (or coating layer) 371 or a second protective layer (or film layer) 373. The first protective layer 371 and the second protective layer 373 may have different moduli. The first protective layer 371 and the second protective layer 373 may be multiply stacked on the glass layer 350 to constitute the protective layer 370, or the first protective layer 371 or the second protective layer 373 may be singly stacked on the glass layer 350 to constitute the protective layer 370. A protective layer 370 of a single stacked structure may be formed on a front surface and/or a back surface of the glass layer 350. The first protective layer 371 may be a first polymer coating layer. The second protective layer 373 may be a second polymer coating layer. A material of the first and/or the second polymer may be, e.g., one of PET, PI, or TPU.

According to an example, the second protective layer 373 may be stacked on a front surface (or upper surface) of the glass layer 350. The stacking of the second protective layer 373 may be made by coating the front surface of the glass layer 350 using a second polymer. The first protective layer 371 may be stacked on a back surface (or lower surface) of the glass layer 350. The stacking of the first protective layer 371 may be made by coating the back surface of the glass layer 350 using a first polymer. The first protective layer 371 and the second protective layer 373 may be sequentially stacked on a side surface (or border surface) of the glass layer 350. This may be made by primarily coating the side surface of the glass layer 350 using the first polymer to generate the first protective layer 371, and then secondarily coating the side surface of the glass layer 350 on which the first protective layer 371 is formed using the second polymer to generate the second protective layer 373. The second protective layer 373 may protect the first protective layer 371 on the side surface of the glass layer 350. The first polymer is advantageous to have a modulus value in a range of 0.001 to 1 MPa to reduce bending repulsive force, but the disclosure is not limited thereto. The second polymer may have a relatively higher modulus than the first polymer. For example, the second polymer may have a modulus in a range of 1 to 100 MPa, but the disclosure is not limited thereto. The second polymer having a relatively higher modulus than the first polymer may protect the side surface of the glass layer 350 or may increase strength of the glass layer 350.

The first protective layer 371 may have a first thickness gap1. The second protective layer 373 may have a second thickness gap2. The first thickness gap1 may be the same as or different from the second thickness gap2. The first thickness gap 1 and/or the second thickness gap2 may be determined based on a degree capable of preventing OCR damage that may occur on the side surface of the glass layer 350. As an example, the first thickness gap1 and/or the second thickness gap2 may be determined based on ‘G_th1<gap1 (or gap2)<G_th2.’ Here, G_th1 is a lower limit threshold (e.g., 0.05 mm) of the first thickness gap1 and/or the second thickness gap2, and G_th2 may be an upper limit threshold (e.g., 1 mm) of the first thickness gap1 and/or the second thickness gap2.

In the description, a structure in which the protective layer 370 is including two coating layers has been designated, but the disclosure is not limited thereto. For example, according to a protective coating method and structure, at least one coating layer may be additionally provided. The additional coating layer may have a different modulus from the first and/or second coating layers. The additional coating layer may be formed on some or all of the front surface, back surface, or side surface of the glass layer 350. Examples of a stacked structure of the protective layer 370 in which the glass layer 350 is coated using materials (e.g., polymers) having at least two moduli is described below with reference to FIGS. 9A, 9B, 9C, 9D, 9E, and 9F.

The slit 351 formed in the folding region 400 of the glass layer 350 may be filled with the first polymer. In the drawings, the slit 351 is illustrated as a through hole (e.g., FIGS. 9A, 9B, 9C, and 9D), but the disclosure is not limited thereto. For example, the slit 351 may be a groove (e.g., a recess of FIG. 9E or 9F) dug to a predetermined depth into the glass layer 350. The slit 351 may be disposed between ribs 353. The first polymer may be a transparent material having a refractive index similar to that of the glass layer 350 so as to reduce occurrence of a sense of difference at a boundary portion with the glass layer 350. The first polymer filled in the slit 351 of the glass layer 350 may not only increase buckling stability in the slit 351, but also prevent OCR damage.

FIGS. 9A, 9B, 9C, 9D, 9E, and 9F are cross-sectional views (e.g., A-A′ of FIG. 5A) of a display protective member (e.g., the display protective member 300 of FIG. 3) included in a flexible display (e.g., the display 140 of FIG. 1 or the display 299 of FIGS. 2A, 2B, 2C, 2D, 2E, and 2F) to which side protective coating is applied according to various embodiments of the disclosure.

Referring to FIG. 9A, a display protective member 300 may include a glass layer 350a having a folding region 400a (e.g., the folding region 400 of FIG. 8A) in which a slit (e.g., through hole) (e.g., the slit 351 of FIG. 8A) and a rib (e.g., the rib 353 of FIG. 8A) are formed in a predetermined pattern.

The display protective member 300 may include a first protective layer 371a coated by Polymer_A to surround the glass layer 350a. For example, the first protective layer 371a may be a layer coated by the Polymer_A to cover an upper surface (e.g., a surface facing the +x direction), a side surface (e.g., a surface facing the ty or −y direction or a surface facing the +z or −z direction), and a lower surface (e.g., a surface facing the −x direction) of the glass layer 350a. The first protective layer 371a covering the side surface of the glass layer 350a may have a predetermined thickness (e.g., the first thickness gap1 of FIG. 8B). The Polymer_A may have the same characteristic as one of the first polymer or the second polymer described with reference to FIG. 8A or 8B. For example, the Polymer_A may be a polymer having a low hardness (e.g., low-hardness OCR). The Polymer_A may fill the slit 351 formed in the folding region 400a of the glass layer 350a.

The display protective member 300 may include a second protective layer 373a coated by Polymer_B to cover an outer surface (e.g., a side surface (e.g., a surface facing the ty or −y direction or a surface facing the +z or −z direction)) of the first protective layer 371a coating the glass layer 350a by the Polymer_A. The second protective layer 373a covering the side surface of the first protective layer 371a coating the glass layer 350a may have a predetermined thickness (e.g., the second thickness gap2 of FIG. 8B). The Polymer_B may have the same characteristic as one of the first polymer or the second polymer described with reference to FIG. 8A or 8B. For example, the Polymer_B may be a polymer having a high hardness (e.g., high-hardness OCR).

According to the description, an outer surface (e.g., a side surface (e.g., a surface facing the +y or −y direction or a surface facing the +z or −z direction)) of the glass layer 350a may be doubly protected by the first protective layer 371a and the second protective layer 373a.

Referring to FIG. 9B, a display protective member 300 may include a glass layer 350b having a folding region 400b (e.g., the folding region 400 of FIG. 8A) in which a slit (e.g., through hole) (e.g., the slit 351 of FIG. 8A) and a rib (e.g., the rib 353 of FIG. 8A) are formed in a predetermined pattern. The display protective member 300 may include a first protective layer 371b and a second protective layer 373b coated by Polymer_A and Polymer_B having different moduli to surround the glass layer 350b.

The first protective layer 371b may be a layer formed by coating the Polymer_A to surround a partial surface of the glass layer 350b. For example, the first protective layer 371b may be a layer coated by the Polymer_A to cover a side surface (e.g., a surface facing the ty or −y direction or a surface facing the +z or −z direction) and a lower surface (e.g., a surface facing the −x direction) of the glass layer 350b. The first protective layer 371b covering the side surface of the glass layer 350b may have a predetermined thickness (e.g., the first thickness gap 1 of FIG. 8B). The Polymer_A may have the same characteristic as one of the first polymer or the second polymer described with reference to FIG. 8A or 8B. For example, the Polymer_A may be a polymer having a low hardness (e.g., low-hardness OCR). The Polymer_A may fill the slit 351 formed in the folding region 400b of the glass layer 350b.

The second protective layer 373b may be a layer formed by coating the Polymer_B to surround a partial surface of the glass layer 350b. For example, the second protective layer 373b may be a layer coated by the Polymer_B to cover an upper surface (e.g., a surface facing the +x direction) of the glass layer 350b and a side surface (e.g., a surface facing the +y or −y direction or a surface facing the +z or −z direction) of the first protective layer 371b coating the glass layer 350b. The second protective layer 373b covering the side surface of the first protective layer 371b coating the glass layer 350b may have a predetermined thickness (e.g., the second thickness gap2 of FIG. 8B). The Polymer_B may have the same characteristic as one of the first polymer or the second polymer described with reference to FIG. 8A or 8B. For example, the Polymer_B may be a polymer having a high hardness (e.g., high-hardness OCR).

According to the description, an outer surface (e.g., a side surface (e.g., a surface facing the +y or −y direction or a surface facing the +z or −z direction)) of the glass layer 350b may be doubly protected by the first protective layer 371b and the second protective layer 373b.

Referring to FIG. 9C, a display protective member 300 may include a glass layer 350c having a folding region 400c (e.g., the folding region 400 of FIG. 8A) in which a slit (e.g., through hole) (e.g., the slit 351 of FIG. 8A) and a rib (e.g., the rib 353 of FIG. 8A) are formed in a predetermined pattern. The display protective member 300 may include a first protective layer 371c, a second protective layer 373c, and a third protective layer 375c coated by Polymer_A, Polymer_B, and Polymer_C having different moduli to surround the glass layer 350c.

The first protective layer 371c may be a layer formed by coating the Polymer_A to surround a partial surface of the glass layer 350c. For example, the first protective layer 371c may be a layer coated by the Polymer_A to cover an upper surface (e.g., a surface facing the +x direction) and a side surface (e.g., a surface facing the +y or −y direction or a surface facing the +z or −z direction) of the glass layer 350c. The first protective layer 371c covering the side surface of the glass layer 350c may have a predetermined thickness (e.g., the first thickness gap1 of FIG. 8B). The Polymer_A may have the same characteristic as one of the first polymer or the second polymer described with reference to FIG. 8A or 8B. For example, the Polymer_A may be a polymer having a low hardness (e.g., low-hardness OCR). The Polymer_A may fill the slit 351 formed in the folding region 400c of the glass layer 350c.

The second protective layer 373c may be a layer formed by coating the Polymer_B to surround a partial surface of the glass layer 350c. For example, the second protective layer 373c may be a layer coated by the Polymer_B to cover an upper surface (e.g., a surface facing the +x direction) of the first protective layer 371b coating the glass layer 350c. The Polymer_B may have the same characteristic as one of the first polymer or the second polymer described with reference to FIG. 8A or 8B. For example, the Polymer_B may be a polymer having a high hardness (e.g., high-hardness OCR).

The third protective layer 375c may be a layer formed by coating the Polymer_C to surround a partial surface of the glass layer 350b. For example, the third protective layer 375c may be a layer coated by the Polymer_C to cover a lower surface (e.g., a surface facing the −x direction) of the glass layer 350b and a side surface (e.g., a surface facing the +y or −y direction or a surface facing the +z or −z direction) of the first protective layer 371c coating the glass layer 350b. The third protective layer 375c covering the side surface of the first protective layer 371c coating the glass layer 350c may have a predetermined thickness (e.g., the second thickness gap2 of FIG. 8B). The Polymer_C may have a different characteristic from the first polymer or the second polymer described with reference to FIG. 8A or 8B. For example, the Polymer_C may be a polymer having a hardness between the hardness of the Polymer_A and the hardness of the Polymer_B (e.g., medium-hardness OCR).

According to the description, an outer surface (e.g., a side surface (e.g., a surface facing the +y or −y direction or a surface facing the +z or −z direction) and an upper surface (e.g., a surface facing the +x direction)) of the glass layer 350c may be doubly protected by the first protective layer 371c and the second protective layer 373c.

Referring to FIG. 9D, a display protective member 300 may include a glass layer 350d having a folding region 400d (e.g., the folding region 400 of FIG. 8A) in which a slit (e.g., through hole) (e.g., the slit 351 of FIG. 8A) and a rib (e.g., the rib 353 of FIG. 8A) are formed in a predetermined pattern. The display protective member 300 may include a first protective layer 371d and a second protective layer 375d coated by Polymer_A and Polymer_C having different moduli to surround the glass layer 350d.

The first protective layer 371d may be a layer formed by coating the Polymer_A to surround a partial surface of the glass layer 350d. For example, the first protective layer 371d may be a layer coated by the Polymer_A to cover a side surface (e.g., a surface facing the ty or −y direction or a surface facing the +z or −z direction) and a lower surface (e.g., a surface facing the −x direction) of the glass layer 350d. The first protective layer 371d covering the side surface of the glass layer 350d may have a predetermined thickness (e.g., the first thickness gap1 of FIG. 8B). The Polymer_A may have the same characteristic as one of the first polymer or the second polymer described with reference to FIG. 8A or 8B. For example, the Polymer_A may be a polymer having a low hardness (e.g., low-hardness OCR). The Polymer_A may fill the slit 351 formed in the folding region 400b of the glass layer 350d.

The second protective layer 375d may be a layer formed by coating the Polymer_C to surround a partial surface of the glass layer 350d. For example, the second protective layer 375d may be a layer coated by the Polymer_C to cover an upper surface (e.g., a surface facing the +x direction) of the glass layer 350d and a side surface (e.g., a surface facing the +y or −y direction or a surface facing the +z or −z direction) of the first protective layer 371d coating the glass layer 350d. The second protective layer 375d covering the side surface of the first protective layer 371d coating the glass layer 350d may have a predetermined thickness (e.g., the second thickness gap2 of FIG. 8B). The Polymer_C may have a different characteristic from the first polymer or the second polymer described with reference to FIG. 8A or 8B. For example, the Polymer_C may be a polymer having a hardness between the hardness of the Polymer_A and the hardness of the Polymer_B (e.g., medium-hardness OCR).

According to the description, an outer surface (e.g., a side surface (e.g., a surface facing the +y or −y direction or a surface facing the +z or −z direction)) of the glass layer 350d may be doubly protected by the first protective layer 371d and the second protective layer 375d.

In addition to the structure of the protective layer 370 illustrated in FIGS. 9A, 9B, 9C, and 9D described above, a medium-hardness OCR may be used as the first polymer to enhance strength of the folding region 400. Further, the entire outer surface of the glass layer 350 may be coated using a medium-hardness OCR that is not tacky. In this case, a side protective coating method and/or structure may be variously applicable as described with reference to FIGS. 9A, 9B, 9C, and 9D.

Referring to FIG. 9E, a display protective member 300 may include a glass layer 350e having a folding region 400e (e.g., the folding region 400 of FIG. 8A) in which a slit (e.g., a recess disposed on a front surface of the glass layer 350e) (e.g., the slit 351 of FIG. 8A) and a rib (e.g., the rib 353 of FIG. 8A) are formed in a predetermined pattern.

The display protective member 300 may include a first protective layer 371e coated by Polymer_A to surround the glass layer 350e. For example, the first protective layer 371e may be a layer coated by the Polymer_A to cover an upper surface (e.g., a surface facing the +x direction) and a side surface (e.g., a surface facing the +y or −y direction or a surface facing the +z or −z direction) of the glass layer 350e. The first protective layer 371e covering the side surface of the glass layer 350e may have a predetermined thickness (e.g., the first thickness gap 1 of FIG. 8B). The Polymer_A may have the same characteristic as one of the first polymer or the second polymer described with reference to FIG. 8A or. 8B. For example, the Polymer_A may be a polymer having a low hardness (e.g., low-hardness OCR). The Polymer_A may fill the slit 351 formed in the folding region 400e of the glass layer 350e.

The display protective member 300 may include a second protective layer 373e coated by Polymer_B to cover an upper surface (e.g., a surface facing the +x direction) and a side surface (e.g., a surface facing the +y or y direction or a surface facing the +z or −z direction) of the first protective layer 371e coating the glass layer 350e by the Polymer_A. The second protective layer 373e covering the side surface of the first protective layer 371e coating the glass layer 350e may have a predetermined thickness (e.g., the second thickness gap2 of FIG. 8B). The Polymer_B may have the same characteristic as one of the first polymer or the second polymer described with reference to FIG. 8A or 8B. For example, the Polymer_B may be a polymer having a high hardness (e.g., high-hardness OCR).

According to the description, an outer surface (e.g., a side surface (e.g., a surface facing the +y or −y direction or a surface facing the +z or −z direction) and an upper surface (e.g., a surface facing the +x direction)) of the glass layer 350e may be doubly protected by the first protective layer 371e and the second protective layer 373e.

Referring to FIG. 9F, a display protective member 300 may include a glass layer 350f having a folding region 400f (e.g., the folding region 400 of FIG. 8A) in which a slit (e.g., a recess disposed on a back surface of the glass layer 350f) (e.g., the slit 351 of FIG. 8A) and a rib (e.g., the rib 353 of FIG. 8A) are formed in a predetermined pattern.

The display protective member 300 may include a first protective layer 371f coated by Polymer_A to surround the glass layer 350f. For example, the first protective layer 371f may be a layer coated by the Polymer_A to cover a lower surface (e.g., a surface facing the −x direction) and a side surface (e.g., a surface facing the +y or −y direction or a surface facing the +z or −z direction) of the glass layer 350f. The first protective layer 371f covering the side surface of the glass layer 350f may have a predetermined thickness (e.g., the first thickness gap1 of FIG. 8B). The Polymer_A may have the same characteristic as one of the first polymer or the second polymer described with reference to FIG. 8A or 8B. For example, the Polymer_A may be a polymer having a low hardness (e.g., low-hardness OCR). The Polymer_A may fill the slit 351 formed in the folding region 400f of the glass layer 350f.

The display protective member 300 may include a second protective layer 373f coated by Polymer_B to cover a side surface (e.g., a surface facing the ty or −y direction or a surface facing the +z or −z direction) of the first protective layer 371f coating the glass layer 350f by the Polymer_A and an upper surface (e.g., a surface facing the +x direction) of the glass layer 350f. The second protective layer 373f covering the side surface of the first protective layer 371f coating the glass layer 350f may have a predetermined thickness (e.g., the second thickness gap2 of FIG. 8B). The Polymer_B may have the same characteristic as one of the first polymer or the second polymer described with reference to FIG. 8A or 8B. For example, the Polymer_B may be a polymer having a high hardness (e.g., high-hardness OCR).

According to the description, an outer surface (e.g., a side surface (e.g., a surface facing the +y or −y direction or a surface facing the +z or −z direction)) of the glass layer 350f may be doubly protected by the first protective layer 371f and the second protective layer 373f.

Even in case that the slit 351 illustrated in FIG. 9E or 9F is configured in a recess form on a front surface or a back surface of the glass layer 350, the first protective layer 371 and the second protective layer 373 of the protective layer 370 illustrated in FIGS. 9A, 9B, 9C, and 9D may be equally applied. A height, shape, and/or OCR modulus of the recess configured in the glass layer 350 may be determined based on an allowable bending R and/or reaction force.

In the description with reference to FIGS. 9A, 9B, 9C, 9D, 9E, and 9F, the low-hardness OCR, the medium-hardness OCR, and the high-hardness OCR may have modulus ranges that partially overlap each other, or are adjacent to each other, or are spaced apart from each other. The low-hardness OCR may have a relatively smaller modulus than the medium-hardness OCR and the high-hardness OCR. The medium-hardness OCR may have a relatively higher modulus than the low-hardness OCR and may have a relatively smaller modulus than the high-hardness OCR. The high-hardness OCR may have a relatively higher modulus than the low-hardness OCR and the medium-hardness OCR. As an example, a modulus range of the low-hardness OCR may be ‘0.001 to 1 MPa,’ a modulus range of the medium-hardness OCR may be ‘1 to 100 MPa,’ and a modulus range of the high-hardness OCR may be ‘100 to 10,000 MPa.’ The low-hardness OCR (or soft OCR) may have a relatively lower elastic modulus than the medium-hardness OCR and the high-hardness OCR. The medium-hardness OCR may have a relatively higher elastic modulus than the low-hardness OCR and may have a relatively lower elastic modulus than the high-hardness OCR. The high-hardness OCR may have a relatively higher elastic modulus than the low-hardness OCR and the medium-hardness OCR.

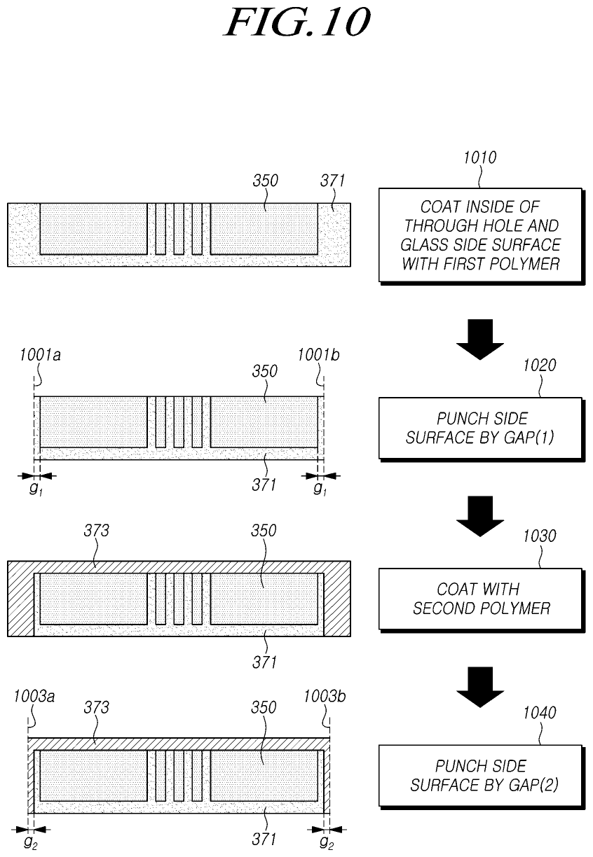

FIG. 10 is a view illustrating a manufacturing process procedure of a display protective member (e.g., the display protective member 300 of FIG. 3) to be included in a flexible display (e.g., the display 140 of FIG. 1 or the display 299 of FIGS. 2A, 2B, 2C, 2D, 2E, and 2F) in a display manufacturing system according to an embodiment of the disclosure.

Referring to FIG. 10, in operation 1010, a display manufacturing system may produce a first product in which a protective layer 371 is configured to surround the glass layer 350 by coating an outer surface of a glass layer (e.g., the glass layer 350 of FIG. 3) using a first polymer. In this case, an inside of a plurality of slits (e.g., through holes) (e.g., the slit 351 of FIG. 5B) formed in a folding region (e.g., the folding region 400 of FIG. 4A) of the glass layer 350 and a side surface (e.g., a surface facing the +y or −y direction or a surface facing the +z or −z direction) of the glass layer may be coated by the first polymer. The first polymer may have the same characteristic as one of the polymers described with reference to FIG. 8A or 8B. For example, the first polymer may be a polymer having a low hardness (e.g., low-hardness OCR). For example, the first polymer may be a polymer having a medium hardness (e.g., medium-hardness OCR). For example, the first polymer may be a polymer having a high hardness (e.g., high-hardness OCR).

In operation 1020, the display manufacturing system may produce a second product by punching 1001a, 1001b a side surface (e.g., a surface facing the +y or −y direction or a surface facing the +z or −z direction) of the first product such that a protective layer 371 (e.g., the first protective layer 371 of FIG. 8A) having a predetermined thickness (e.g., the first thickness g₁ of FIG. 8B) remains. A laser punching method may be used for the punching 1001a, 1001b.

In operation 1030, the display manufacturing system may produce a third product in which a second protective layer 373 is configured to surround the second product by coating an outer surface of the second product using a second polymer. As an example, a side surface (e.g., a surface facing the ty or −y direction or a surface facing the +z or −z direction) and an upper surface (e.g., a surface facing the +x direction) of the second product may be coated by the second polymer. As an example, only a side surface (e.g., a surface facing the +y or −y direction or a surface facing the +z or −z direction) of the second product may be coated by the second polymer. The second polymer may have the same characteristic as one of the polymers described with reference to FIG. 8A or 8B. The second polymer may have a different modulus from the first polymer. For example, the second polymer may be one of a polymer having a low hardness (e.g., low-hardness OCR), a polymer having a medium hardness (e.g., medium-hardness OCR), or a polymer having a high hardness (e.g., high-hardness OCR).

In operation 1040, the display manufacturing system may produce a display protective member 300 corresponding to a final product by punching 1003a, 1003b a side surface (e.g., a surface facing the +y or −y direction or a surface facing the +z or −z direction) of the third product such that a second protective layer 373 (e.g., the second protective layer 373 of FIG. 8A) having a predetermined thickness (e.g., the second thickness g2 of FIG. 8B) remains. A laser punching method may be used for the punching 1003a, 1003b. The produced display protective member 300 may have various side protective coating methods and/or structures as described with reference to FIGS. 9A, 9B, 9C, 9D, 9E, and 9F in addition to what is illustrated.

Although not illustrated, in case of adding coating using a third polymer, the display manufacturing system may additionally perform a coating operation using the third polymer after performing operation 1040.

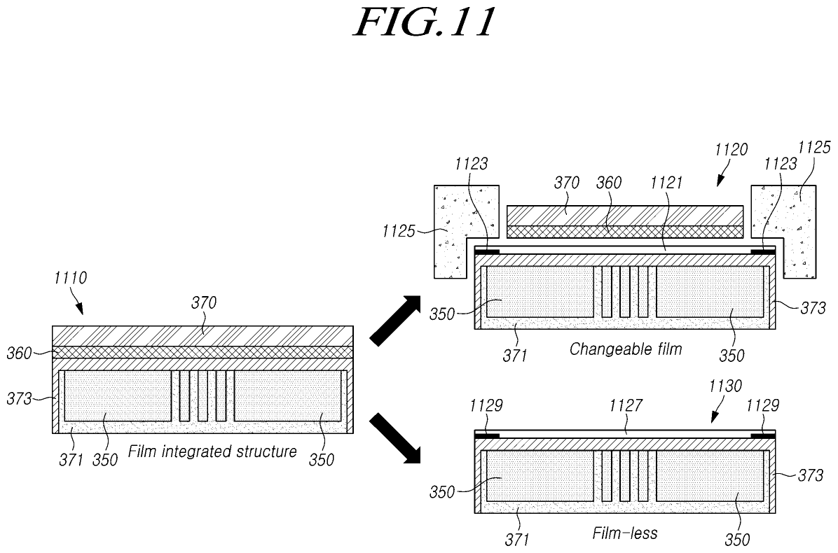

FIG. 11 is a view illustrating examples to which a side protective coating structure of a flexible display (e.g., the display 140 of FIG. 1 or the display 299 of FIGS. 2A, 2B, 2C, 2D, 2E, and 2F) may be applied according to an embodiment of the disclosure.

Referring to FIG. 11, a display protective member 1110 (e.g., the display protective member 300 of FIG. 3) in which a plurality of coating layers 371, 373 are formed using different polymers on a side surface of a glass layer 350 for side protection may also be applied to a structure integrated with a protective film. As an example, an OCA layer (e.g., second adhesive layer 360) and/or a protective layer 370 may be sequentially stacked on an upper surface of the display protective member 1110.

According to an example, a display protective member 1120 or 1130 with a cover window 1129 (e.g., the display protective member 300 of FIG. 3) in which a plurality of coating layers 371, 373 are formed using different polymers on a side surface of a glass layer 350 for side protection may also be applied to a changeable film structure. As an example, a cover window 1123, 1125 capable of replacing a protective layer 370 is additionally implemented near a border on an upper surface of the display protective member 1120. An HC+AF layer 1121 or 1127 may be stacked on an upper surface of the display protective member 1120 or 1130.

According to an example, by performing hard coating and AF treatment on an upper surface of an upper polymer, it may be applicable to a cover window with a thick glass alone. In this case, if a BM printing layer is added to a border of the cover window, implementation by a deco-less structure may also be possible.

Various embodiments of the above-described disclosure may be utilized for a rollable electronic device in addition to a foldable electronic device from a bendable cover window. In this case, the application may be extended not only to mobile but also to a tablet or notebook personal computer (PC) requiring a thick glass.

According to an embodiment of the disclosure, an electronic device 200 may include a display 299 having a folding region 400 bendable by a predetermined angle or more in at least one direction. In the electronic device 200, a rib 353 and a slit 351 of a specific pattern may repeatedly extend in a direction parallel to a folding axis A in a glass layer 350 included in the folding region 400. A slit length D3 corresponding to a distance between a first bridge corresponding to a start point of the slit 351 and a second bridge corresponding to an end point of the slit 351 may be determined based on at least one of a thickness of the glass layer 350 or a modulus of a polymer filling the slit 351. The first bridge and the second bridge may be configured to connect a first rib and a second rib disposed in parallel on two opposite sides of the slit 351.

According to an embodiment of the disclosure, the slit length D3 may be determined in proportion to the thickness of the glass layer 350.

According to an embodiment of the disclosure, the slit length D3 may be determined in proportion to the modulus of the polymer filling the slit 351.

According to an embodiment of the disclosure, the slit length D3 may be 2 mm or more.

According to an embodiment of the disclosure, the slit length D3 may be determined in a range of 2 mm to 12 mm.

According to an embodiment of the disclosure, a width of the rib 353 may be 0.5 mm or less.

According to an embodiment of the disclosure, a width of the first bridge or the second bridge may be 0.5 mm or less.

According to an embodiment of the disclosure, the specific pattern may be one of a chevron shape or a V shape.

According to an embodiment of the disclosure, the specific pattern may have a straight shape considering an light emitting diode (LED) arrangement for moire reduction corresponding to a panel layer 310 disposed below the glass layer and the slit length D3.

According to an embodiment of the disclosure, the number of times that the V-shaped specific pattern is continuously repeated may be determined based on the slit length D3, and the predetermined number of times may be two or more.

According to an embodiment of the disclosure, the slit length D3 may be determined based on at least one of a width or a number of repetitions of the V-shaped specific pattern.

According to an embodiment of the disclosure, a plurality of slits and a plurality of ribs may extend in a direction perpendicular to the folding axis A in the folding region.

According to an embodiment of the disclosure, start points and end points of odd-numbered slits included in the plurality of slits may be disposed to coincide in a perpendicular direction at a first position of the folding axis.

According to an embodiment of the disclosure, start points and end points of even-numbered slits included in the plurality of slits may be disposed to coincide in a perpendicular direction at a second position of the folding axis.

According to an embodiment of the disclosure, a plurality of slits and a plurality of ribs may extend in a direction perpendicular to the folding axis A in the folding region, and start points and end points of the plurality of slits may be disposed to be offset in the perpendicular direction of the folding axis A.

According to an embodiment of the disclosure, the display 299 may include a panel layer 310 displaying visual information, the glass layer 350 stacked to be positioned over a screen on which the visual information is displayed in the panel layer 310, and a protective layer 370 in which a side surface of the glass layer 350 is sequentially coated by at least two polymers having different moduli.

According to an embodiment of the disclosure, the slit 351 may be filled with a polymer having a relatively low modulus among the at least two polymers.

According to an embodiment of the disclosure, the protective layer 370 on the side surface of the glass layer 350 may include a first coating layer generated by a primary coating with a first polymer included in the at least two polymers, and a second coating layer generated by a secondary coating with a second polymer included in the at least two polymers, and the first polymer may have a relatively lower modulus than the second polymer.

According to an embodiment of the disclosure, the protective layer 370 on the side surface of the glass layer 350 may include a first coating layer generated by a primary coating with a first polymer included in the at least two polymers, and a second coating layer generated by a secondary coating with a second polymer included in the at least two polymers, and the first polymer may have a relatively lower elastic modulus than the second polymer.

According to an embodiment of the disclosure, a thickness of the first coating layer or the second coating layer on the side surface of the glass layer 350 may be determined in a range of 0.05 mm to 1 mm.

According to an embodiment of the disclosure, the polymer filling the slit 351 may have substantially the same refractive index as the glass layer 350.

According to an embodiment of the disclosure, the slit 351 may be a through hole.

According to an embodiment of the disclosure, the slit 351 may be a recess.

According to an embodiment of the disclosure, the thickness of the glass layer 350 may be included within a range of 50 μm to 500 μm.

The terms as used herein are provided merely to describe some embodiments thereof, but are not intended to limit the disclosure. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs including instructions that, when executed, implement various embodiments of the disclosure. Accordingly, various embodiments provide a program including code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a display having a folding region bendable by a predetermined angle in at least one direction,
wherein a rib and a slit of a specific pattern repeatedly extend in a direction parallel to a folding axis in a glass layer included in the folding region,
wherein a slit length corresponding to a distance between a first bridge corresponding to a start point of the slit and a second bridge corresponding to an end point of the slit is determined based on at least one of a thickness of the glass layer or a modulus of a polymer filling the slit, and
wherein the first bridge and the second bridge are configured to connect a first rib and a second rib disposed in parallel on two opposite sides of the slit.

2. The electronic device of claim 1, wherein the slit length is determined in proportion to the thickness of the glass layer or the modulus of the polymer filling the slit.

3. The electronic device of claim 1, wherein the slit length is determined in a range of 2 mm to 12 mm.

4. The electronic device of claim 1, wherein a width of the rib, the first bridge, or the second bridge is 0.5 mm or less.

5. The electronic device of claim 1, wherein the specific pattern has a straight shape considering an light emitting diode (LED) arrangement for moire reduction corresponding to a panel layer disposed below the glass layer and the slit length.

6. The electronic device of claim 1,
wherein a number of times that the specific pattern having a chevron shape or a V shape is continuously repeated is determined based on the slit length, and
wherein the number of times is two or more.

7. The electronic device of claim 1, wherein the slit length is determined based on at least one of a width or a number of repetitions of the specific pattern.

8. The electronic device of claim 1,
wherein a plurality of slits and a plurality of ribs extend in a direction perpendicular to the folding axis in the folding region,
wherein start points and end points of odd-numbered slits included in the plurality of slits are disposed to coincide in a perpendicular direction at a first position of the folding axis, and
wherein start points and end points of even-numbered slits included in the plurality of slits are disposed to coincide in a perpendicular direction at a second position of the folding axis.

9. The electronic device of claim 1,
wherein a plurality of slits and a plurality of ribs extend in a direction perpendicular to the folding axis in the folding region, and
wherein start points and end points of the plurality of slits are disposed to be offset in the perpendicular direction of the folding axis.

10. The electronic device of claim 1,
wherein the display includes:
a panel layer displaying visual information;
the glass layer stacked to be positioned over a screen on which the visual information is displayed in the panel layer; and
a protective layer in which a side surface of the glass layer is sequentially coated by at least two polymers having different moduli, and
wherein the slit is filled with a polymer having a relatively low modulus among the at least two polymers.

11. The electronic device of claim 10,
wherein the protective layer on the side surface of the glass layer includes:
a first coating layer generated by a primary coating with a first polymer included in the at least two polymers; and
a second coating layer generated by a secondary coating with a second polymer included in the at least two polymers, and
wherein the first polymer has a relatively lower modulus than the second polymer.

12. The electronic device of claim 11, wherein a thickness of the first coating layer or the second coating layer on the side surface of the glass layer is determined in a range of 0.05 mm to 1 mm.

13. The electronic device of claim 10,
wherein the protective layer on the side surface of the glass layer includes:
a first coating layer generated by a primary coating with a first polymer included in the at least two polymers; and
a second coating layer generated by a secondary coating with a second polymer included in the at least two polymers, and
wherein the first polymer has a relatively lower elastic modulus than the second polymer.

14. The electronic device of claim 13, wherein a thickness of the first coating layer or the second coating layer on the side surface of the glass layer is determined in a range of 0.05 mm to 1 mm.

15. The electronic device of claim 10, wherein the polymer filling the slit has substantially the same refractive index as the glass layer.

16. The electronic device of claim 1, wherein the slit is one of a through hole or a recess, and wherein the thickness of the glass layer is included within a range of 50 μm to 500 μm.
